(19) United States
(12) Patent Application Publication
(10) Pub. No.: US 2023/0199565 A1
(43) Pub. Date: Jun. 22, 2023

(54) METHODS AND DEVICES FOR MANAGEMENT OF THE RADIO RESOURCES

(71) Applicant: Intel Corporation, Santa Clara, CA (US)

(72) Inventors: Rath VANNITHAMBY, Portland, OR (US); Kathiravetpillai SIVANESAN, Portland, OR (US); Shilpa TALWAR, Cupertino, CA (US)

(21) Appl. No.: 17/555,560

(22) Filed: Dec. 20, 2021

(51) Int. Cl. H04W 28/08; H04W 28/02; H04L 1/00; H04W 24/10; H04L 1/18; H04W 72/12; H04W 28/04

(52) U.S. Cl. CPC H04W 28/0983; H04W 28/0268; H04W 28/0278; H04L 1/0026; H04W 24/10; H04L 1/1812; H04W 72/1268; H04W 28/04

(57) ABSTRACT

A device may include a memory configured to store channel quality data comprising information indicating a quality of a communication channel between a base station (BS) and a user equipment (UE). The device may further include a processor configured to provide an input comprising the channel quality data to a machine learning model configured to predict a channel quality indicator (CQI) based on the input and encode a channel quality information based on the predicted CQI for a transmission to the BS.

### TECHNICAL FIELD

This disclosure generally relates to methods and devices for management of the radio resources.

### BACKGROUND

In various radio access technologies such as Fourth Generation (LTE) and Fifth Generation (5G) New Radio (NR), there are various techniques that are applied for resource allocation of radio resources for terminal devices in terms of time and frequency resources with an intention to maintain related Quality of Services (QoS) requirements. In order to allocate radio resources, network access nodes may employ various metrics which some are based on measurements with respect to the communication channels between the network access modes and terminal devices with an intention to allocate the limited radio resources between the terminal devices and manage the radio resources in an effective manner. It may further be desirable for terminal devices to convey information affecting the resource management of the network access nodes.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows exemplary radio communication network;

FIG. 2 shows an exemplary internal configuration of a communication device;

FIG. 3A shows an illustration with respect to periodic CSI reports including a CQI in a radio communication system;

FIG. 3B shows an illustration with respect to aperiodic CSI request including a CQI in a radio communication system;

FIG. 4 shows an example of a device;

FIG. 5 shows an example of a processor and a memory of a device according to various aspects provided in this disclosure;

FIG. 6 exemplarily illustrates a flow diagram;

FIG. 7 exemplarily shows an illustration with respect to the controller;

FIG. 8 shows an example of an AI/ML;

FIG. 9 exemplarily shows an illustration of an AI/ML;

FIG. 10 exemplarily shows an illustration with respect to an AI/ML;

FIG. 11 exemplarily shows an illustration with respect to an AI/ML;

FIG. 12 shows an example of a method;

FIG. 13 shows an example of a device;

FIG. 14 shows an example of a processor and a memory of a device according to various aspects provided in this disclosure;

FIG. 15 shows an example of an AI/ML;

FIG. 16 exemplarily shows an illustration of an AI/ML;

FIG. 17 shows an example of a method;

FIG. 18 shows an example of a device;

FIG. 19 shows an example of a processor and a memory of a device according to various aspects provided in this disclosure;

FIG. 20 shows an example of an AI/ML;

FIG. 21 exemplarily shows an illustration of an AI/ML;

FIG. 22 shows an example of a method;

FIG. 23 shows an example of a device;

FIG. 24 shows an example of a processor and a memory of a device according to various aspects provided in this disclosure;

FIG. 25 shows an example of an AI/ML;

FIG. 26 exemplarily shows an illustration of an AI/ML;

FIG. 27 shows an example of a method;

FIG. 28 exemplarily shows an illustration of a radio access network;

FIG. 29 shows an illustration with respect to AI/ML

FIG. 30 illustrates an exemplary wireless network;

FIG. 31 is a block diagram illustrating components, according to some example aspects.

### DESCRIPTION

The following detailed description refers to the accompanying drawings that show, by way of illustration, exemplary details and aspects in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

The apparatuses and methods of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies), and may use various spectrum bands including, but not limited to, IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 64-71 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above. Furthermore, the apparatuses and methods described herein can also employ radio communication technologies on a secondary basis on bands such as the TV White Space bands (typically below 790 MHz) where e.g. the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or OFDM flavors (CP-OFDM, SC-FDMA, SC-OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e. unidirectional or bidirectional communication in one or both of the incoming and outgoing directions. The term “calculate” encompass both ‘direct’ calculations via a mathematical expression/formula/relationship and ‘indirect’ calculations via lookup or hash tables and other array indexing or searching operations. The term “channel state information” is used herein to refer generally to the wireless channel for a wireless transmission between one or more transmitting antennas and one or more receiving antennas and may take into account any factors that affect a wireless transmission such as, but not limited to, path loss, interference, and/or blockage.

An antenna port may be understood as a logical concept representing a specific channel or associated with a specific channel. An antenna port may be understood as a logical structure associated with a respective channel (e.g., a respective channel between a user equipment and a base station). Illustratively, symbols (e.g., OFDM symbols) transmitted over an antenna port (e.g., over a first channel) may be subject to different propagation conditions with respect to other symbols transmitted over another antenna port (e.g., over a second channel).

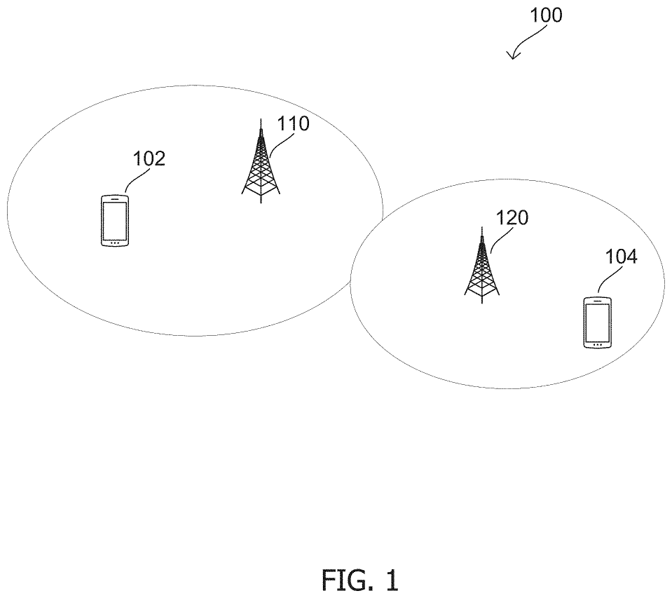

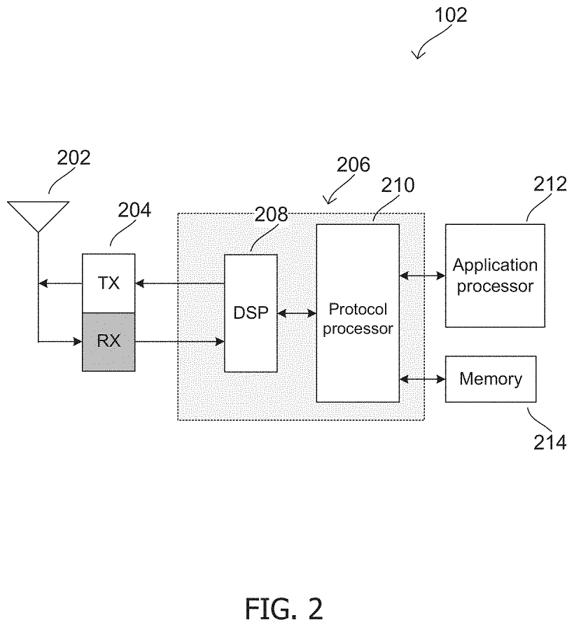

FIGS. 1 and 2 depict a general network and device architecture for wireless communications. In particular, FIG. 1 shows exemplary radio communication network 100 according to some aspects, which may include terminal devices 102 and 104 and network access nodes 110 and 120. Radio communication network 100 may communicate with terminal devices 102 and 104 via network access nodes 110 and 120 over a radio access network. Although certain examples described herein may refer to a particular radio access network context (e.g., LTE, UMTS, GSM, other 3rd Generation Partnership Project (3GPP) networks, WLAN/WiFi, Bluetooth, 5G NR, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks. Network access nodes 110 and 120 and terminal devices 102 and 104 may include one or multiple transmission/reception points (TRPs).

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, WiFi, mmWave, etc., any of which may be applicable to radio communication network 100.

FIG. 2 shows an exemplary internal configuration of a communication device. The communication device may include a terminal device 102 according to some aspects, and it will be referred to as terminal device 102, but the communication device may also include various aspects of network access nodes 110, 120 as well. The terminal device 102 may include antenna system 202, radio frequency (RF) transceiver 204, baseband modem 206 (including digital signal processor 208 and protocol controller 210), application processor 212, and memory 214. Although not explicitly shown in FIG. 2, in some aspects terminal device 102 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Terminal device 102 may transmit and receive radio signals on one or more radio access networks. Baseband modem 206 may direct such communication functionality of terminal device 102 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of terminal device 102 shown in FIG. 2 depicts only a single instance of such components.

Terminal device 102 may transmit and receive wireless signals with antenna system 202. Antenna system 202 may be a single antenna or may include one or more antenna arrays that each include multiple antenna elements. For example, antenna system 202 may include an antenna array at the top of terminal device 102 and a second antenna array at the bottom of terminal device 102. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAs), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 208 may be realized as a coupled integrated circuit.

Terminal device 102 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of terminal device 102 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of terminal device 102 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio terminal device 102 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Terminal device 102 may also include application processor 212 and memory 214. Application processor 212 may be a CPU, and may be configured to handle the layers above the protocol stack, including the transport and application layers. Application processor 212 may be configured to execute various applications and/or programs of terminal device 102 at an application layer of terminal device 102, such as an operating system (OS), a user interface (UI) for supporting user interaction with terminal device 102, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of terminal device 102, such as a hard drive or another such permanent memory device. Although not explicitly depicted in FIG. 2, the various other components of terminal device 102 shown in FIG. 2 may additionally each include integrated permanent and non-permanent memory components, such as for storing software program code, buffering data, etc.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select \ available network access nodes in order to maintain a strong radio access connection with the radio access network of radio communication network 100. For example, terminal device 102 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

In 3GPP mobile radio communication standards, such as LTE or 5G, a terminal device may inform a network access node that the terminal device is connectively coupled to about the quality of the communication channel between the terminal device and the network access node. Terminal devices may employ various techniques to obtain a metric representing the quality of the communication channel that may principally include receiving a reference signal (e.g. a channel state information reference signal (CSI-RS)) and performing various types of measurement to determine a quality of the communication channel and map the determined quality to a predefined index.

In 5G NR, terminal devices may provide information indicating the quality of the communication channel between the network access node (e.g. a base station) and the terminal devices by sending a message including a channel quality indicator (CQI) to the base station (BS). The terminal device may indicate the channel quality according to various predefined CQI indices with respect to different modulation schemes. The random nature of the radio communication channels, traffic arrival, and spatial distribution of terminal devices may allow the measurements to provide valuable information for the BS. Accordingly, CQI measurements may provide an insight to the BS with respect to the determination of the amount of data that can be sent over the communication channel, and how much protection in terms of redundancy is needed for the data.

The terminal device may send the CQI to the BS with further information that may include a precoding matrix index (PMI) selected by the terminal device and a rank indicator. The terminal device may send the CQI to the BS periodically based on the configuration of the radio communication network, or aperiodically. Based on received CQI from also other terminal devices that the BS may serve, the BS may allocate time and frequency resources for the terminal devices.

It may be desirable for the BS to receive CQIs frequently in order to allocate the resources including determining a modulation and coding scheme (MCS) for the communication between each terminal device and the BS. Naturally, the allocation of the resources in order to receive CQI information from each terminal device in the radio communication network may result in allocating some of the resources that may be used for transmitting data. On the other hand, a choice with respect to a lower duty cycle for the CQI feedback may result in unnecessary retransmissions in the radio communication network, impact QoS, and overall system capacity reduction, etc.

Furthermore, the CQI feedback may depend on measurements at a certain instance of time, and the BS may allocate resources with respect to the particular CQI feedback depending on the measurements at the certain instance of time, however, the quality of the corresponding communication channel may change in time, and a longer period of time between the corresponding measurement and the usage of the BS of the CQI with respect to that measurement may result in a higher difference in terms of the channel quality.

In accordance with various aspects of this disclosure, it may be desirable to use a machine learning model to determine and predict a CQI based on predefined inputs with an intention to obtain a determination for the CQI and it may be further desirable to reduce CQI feedback overhead. Furthermore, in various examples, it may be desirable to replace various functions, such as averaging, filtering, interpolating/extrapolating, transformations, etc. with the machine learning module. It may be further desirable to employ the machine learning model with an intention to improve QoS performance and overall system capacity and obtain accurate CQI values. In various examples, such a machine learning model may operate with physical layer (PHY) functions or medium access control layer (MAC) functions.

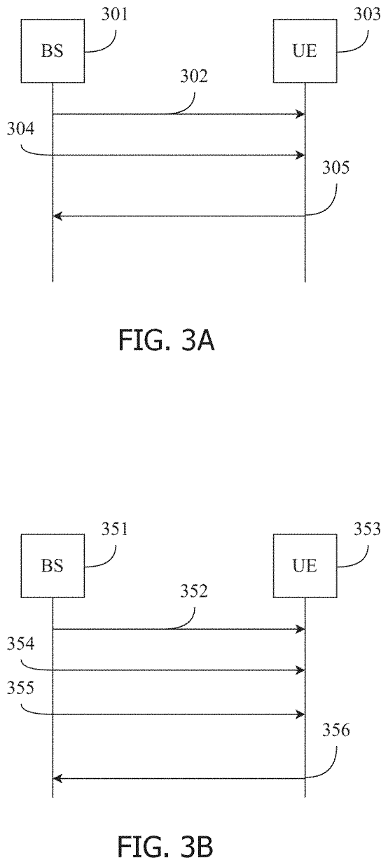

FIG. 3A shows an illustration with respect to periodic CSI reports including a CQI in a radio communication system. In this illustrative example, a BS 301 may perform 302 a higher layer radio resource configuration (RRC) with a terminal device (e.g. UE) 303. The BS 301 may include an evolved node B (eNB) or a next generation node B (gNB). In this illustrative example, after the terminal device in the RRC_CONNECTED mode, the BS 301 may send 304 reference signals such as CSI-RSs. UE 303 may perform measurements with respect to received reference signals and perform a channel estimation based on received reference signals to determine a quality of the communication channel. Based on the channel estimation, the UE 303 may determine a CQI index and send 305 information indicating the CQI index to the BS 301. Based on the received CQI index, the BS 301 may allocate time and frequency resources for the UE 303, determine a MCS index for the UE 303, etc. The BS 301 may transmit CSI-RS periodically to configure radio resources for the UE 303.

FIG. 3B shows an illustration with respect to aperiodic CSI requests including a CQI in a radio communication system. In this illustrative example, a BS 351 may perform 352 a higher layer radio resource configuration (RRC) with a terminal device (e.g. UE) 353. Furthermore, the BS 351 may send 354 a message to trigger a lower layer operation at the UE 353 indicating a CSI-RS transmission. In response to the received message, the UE 353 may begin listening to the communication channel to receive reference signals. Within X slots, the BS 351 may further transmit CSI-RS to the UE 353. UE 353 may perform measurements with respect to received reference signals and perform a channel estimation based on received reference signals to determine a quality of the communication channel. Based on the channel estimation, the UE 353 may determine a CQI index and send 355 information indicating the CQI index to the BS 351. Based on received CQI index, the BS 351 may allocate time and frequency resources for the UE 353, determine a MCS index for the UE 353, etc.

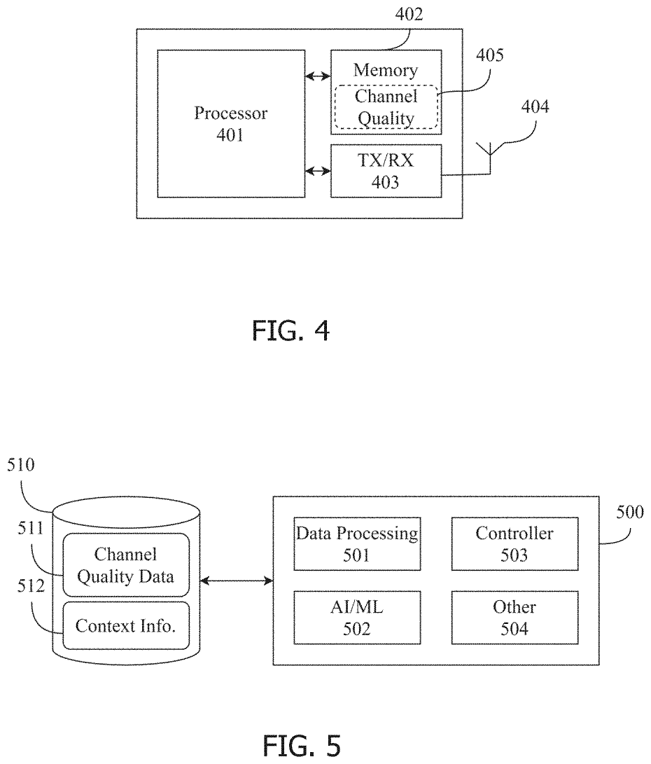

FIG. 4 shows an example of a device according to various examples in this disclosure. The device is depicted as a radio communication device in this illustrative example, comprising a processor 401, a memory 402, and a transceiver 403 configured to receive and transmit radio communication signals using an antenna element 404. The illustration depicts that there is one antenna element coupled to the transceiver 403, however, this should not be considered as limiting, and the radio communication device may be coupled to any number of antenna elements. The transceiver 403 may include a plurality of antenna ports couplable to a plurality of antenna elements. The processor 401 may include one or more processors which may include a baseband processor and an application processor.

The memory 402 may be configured to store channel quality data 405 including one or more measurement results indicating measurements of received radio communication signals from another device. In various examples, the radio communication signals may include downlink radio communication signals received by a UE from a BS. In various examples, the radio communication signals may include uplink radio communication signals received by a BS from a UE. The device may include a measurement circuit to measure the received radio communication signals to obtain the one or more measurement results. The transceiver 403 may include the measurement circuit according to the configuration of the device in which the measurement circuit may measure the received uplink radio communication signals and/or the received downlink radio communication signals.

The measurement circuit may measure the received radio communication signals based on in-phase and quadrature samples (IQ samples). Accordingly, the one or more measurement results may include information (e.g. power) of the IQ samples for one or more received radio communication signals. The measurement circuit may generate a plurality of fast Fourier transform (FFT) sample values based on the received radio communication signals. Accordingly, the one or more measurement results may include information of the plurality of FFT samples of on one or more received radio communication signals. The measurement circuit may measure the power of a received radio communication signal over a defined bandwidth, and the processor 401 may obtain reference signal received power (RSRP), a received signal strength indicator (RSSI), or reference signal received quality (RSRQ) values based on the measured power. Accordingly, the one or more measurement results 405 may include RSRPs, RSSIs, and/or RSRQs, or any other forms of processed signals.

Furthermore, the channel quality data 405 may include a plurality of values indicating the channel quality at a plurality of instances of time. For example, the processor 401 may perform a mapping operation based on previous measurement results of the device to obtain the values. The plurality of values indicating the channel quality may be CQI indices. Accordingly, the processor 401 may store previously calculated CQI indices for a plurality of previous time instances in the channel quality data 405.

In various examples, the channel quality data 405 may include data pairs including a measurement result and a value indicating the channel quality. A data pair may exemplarily include IQ samples or FFT samples of a received reference signal and a resulting CQI index based on power measurements. In various examples, after providing a CQI report to a BS, and the BS has configured radio resources for the device in response to the provided CQI report, the device may perform further measurements to obtain measurement results with the configured radio resources according to the reported CQI index. Accordingly, a data pair may include a measurement result in radio resources configured with a reported CQI, and the reported CQI.

The processor 401 may predict a channel quality indicator parameter based on the channel quality data 405 using a trained machine learning model. The processor 401 may provide the channel quality data 405 to an input of an artificial intelligence/machine learning model (AI/ML). The AI/ML may include a trained AI/ML. The AI/ML may be configured to provide an output including a CQI parameter based on the input of the AI/ML. In various examples, the CQI parameter may include a predicted CQI index. The processor 401 may implement the AI/ML based on a plurality of machine model parameters stored in the memory, or provide the channel quality data 405 to an external processor or an external computing device that is configured to implement the AI/ML as provided in this disclosure. The processor 401 may include an accelerator or a neuromorphic processor to implement the AI/ML.

In various examples, the memory 402 may further store context information (not shown) including information representing a plurality of attributes with respect to the device and the radio connection between the device and the other communication device. The context information may include attributes in which the device performed the one or more measurements, or attributes in which the device operates in an established radio connection with the other communication device.

The processor 401 may generate the context information according to the operations of the device when the device is connected to the other communication device over the radio connection. The processor 401 may access the required information for the context information through various sources, such as RRC configuration messages exchanged between the BS and the UE, Medium Access Layer (MAC) information exchanged between the BS and the UE, UE information that is stored in a memory (e.g. the memory 402), etc. The processor 401 may access the information that is stored in the memory 402 for other operations to obtain the information with respect to the context information when it is desired and perform operations as provided in this disclosure. At least for the context information that the processor 401 may generate, the processor 401 may further store time information for the respective attribute. The time information may indicate the instance of time that the processor 401 has generated the respective portion of the context information, or the instance of time that the processor 401 respective portion of the context information relates to. Furthermore, once the respective AI/ML provides an output, the processor 401 may perform various actions with respect to the output of the AI/ML.

FIG. 5 shows an example of a processor and a memory of a device according to various aspects provided in this disclosure. The processor 500 is depicted to include various functional modules that are configured to provide various functions respectively. The skilled person would recognize that the depicted functional modules are provided to explain various operations that the processor 500 may be configured to. Similarly, the memory 510 is depicted to include the channel quality data 511 and the context information 512 as blocks, however, the memory may store the channel quality data 511 and the context information 512 in any kind of configuration, which may further be provided in this disclosure in various examples. Furthermore, the AI/ML module 502 is depicted as it is implemented in the processor 500 only as an example, and any type of AI/ML implementations which may include the implementation of the AI/ML in an external processor, such as an accelerator, a graphics processing unit (GPU), a neuromorphic chip, or in a cloud computing device, or in a memory (e.g. the memory 510) may also be possible according to any methods.

The processor 500 may include a data processing module 501 that is configured to process the data and generate at least a portion of the channel quality data 511 and/or the context information 512 as provided in various examples in this disclosure. In various examples, the channel quality data 511 and the context information 512 may include information for the past operations that the device has performed in the past for at least within a period of time in a plurality of instances of time. The data processing module 501 may generate a portion of the channel quality data 511 and the context information 512 according to the operations of the device. The channel quality data 511 may include one measurement result (e.g. the latest measurement result) along with the context information 512.

As an example, the data processing module 501 may track the measurements that a measurement circuit may perform and store the results of the measurements as the measurements results 511. Furthermore, the data processing module 501 may access information directly for a portion of context information 512 that is already stored in the memory 510 for operations of other entities. For example, the memory 510 may include already the information related to the UE (e.g. location, velocity, mobility, etc.) for other operations, so the data processing module 501 may not generate the same information to regard that particular information as the context information 512. The data processing module 501 may obtain the information to be used as the context information 512 based on exchanged messages between the BS and the UE. The data processing module 501 may obtain various information from messages received from the BS.

The context information 512 may include information with respect to a plurality of attributes about the device and activities of the device. The context information 512 may include information which the AI/ML 502 may use to predict a CQI parameter, especially to predict a CQI index to be used for the radio communication between the device and the other device.

For example, the context information 512 may include location information indicating the location of the device. The device may obtain the location information via various known methods. In various examples, the location information may include a velocity of the device, or a moving direction of the device. The moving direction of the device may include a moving direction relative to the BS. The location information may include information indicating whether the device is at a fixed location or whether the device is moving.

The precision level with respect to the location information may be at various levels. For example, the location information may indicate the moving direction relative to the BS using indications with respect to the device moving towards the BS, the device moving away from the BS, or the device moving sideways relative to the BS. In case the device is implemented in a UE, the location may include the current location of the UE. The location information may provide an insight for the AI/ML 502 to consider the distance between the UE and the BS, since the distance may affect the channel quality and also may indicate a changing rate of the values with respect to the channel quality in time. In various examples, the context information 512 may include a plurality of locations for a plurality of instances of time.

Furthermore, the context information 512 may include an identifier for a network operator operating through the BS, or an identifier of the BS, since such information may also provide an insight to the AI/ML 502 for a prediction to apply for a specific BS or a network operator. Furthermore, the processor (e.g. the other processing functions 504) may measure uplink data rate or downlink data rate for a period of time and store the uplink data rate and/or downlink data rate as the context information 512. Data rate information may provide an insight for the AI/ML, since higher data rates may indicate a better channel quality and lower data rates may indicate a bad channel quality for the prediction of the CQI parameter.

Furthermore, the context information 512 may include previous modulation levels that the device has used radio resources. The modulation level information may include previously set MCS indices for the device. Furthermore, the context information 512 may include mode information representing the mode of the radio communication network. Furthermore, the context information 512 may include a measured downlink or uplink rate for a period of time.

Furthermore, the context information 512 may include modulation level information indicating the order of the modulation for the radio communication. The data processing module 501 may obtain the modulation level information with respect to the corresponding RRC configuration (e.g. the latest RRC) or with respect to a plurality of past RRC configurations. Furthermore, the context information 512 may include one or more previous power levels used for the radio communication.

The context information 512 may also include a number of resource blocks allocated for the device by the BS, or a number of retransmissions to transmit radio communication signals to the BS. The number of retransmissions to transmit radio communication signals may include hybrid automatic repeat request (HARQ) retransmissions. In various examples, the device may determine the number of retransmissions based on a received HARQ feedback from the BS.

Furthermore, the context information 512 may include an indication for at least one of a first instance of time of a generation of at least one previous CQI, a second instance of time of a transmission of information comprising an indication of the at least one previous CQI, or a third instance of time of a downlink communication scheduled in response to the at least one previous CQI, or a predetermined time gap information representing a period of time between a generation of the channel quality information and a reception of the generated channel quality information by the BS. There may be a time delay between when the device generates a CQI value for a transmission to the BS, and where the corresponding BS uses the CQI value to configure the radio resources for the device. Accordingly, such information may be desirable for the AI/ML module 502 to perform the prediction based on the time delay.

The AI/ML module 502 may implement an AI/ML. The AI/ML may receive input data including the channel quality data 511 and the context information 512, and the AI/ML may predict a CQI parameter for the communication channel between the UE and the BS based on the input data. The processor 500 may further include a controller 503 to control the AI/ML module 502. The controller 503 may provide the input data to the AI/ML, or provide the AI/ML module 502 instructions to perform the prediction.

The AI/ML module 502 may implement an AI/ML. The AI/ML may be any type of machine learning model configured to receive the input data and provide an output as provided in this disclosure. The AI/ML may include any type of machine learning model suitable for the purpose. The AI/ML may include a neural network, including various types of neural networks. The neural network may be a feed-forward neural network in which the information is transferred from lower layers of the neural network close to the input to higher layers of the neural network close to the output. Each layer includes neurons that receive input from a previous layer and provide an output to a next layer based on certain weight parameters adjusting the input information.

The AI/ML may include a convolutional neural network (CNN), which is an example for feed-forward neural networks that may be used for the purpose of this disclosure, in which one or more of the hidden layers of the neural network include a convolutional layer that performs convolutions for their received input from a lower layer. The CNNs may be helpful for pattern recognition and classification operations. The CNN may further include pooling layers, fully connected layers, and normalization layers.

The AI/ML may include a recurrent neural network in which the neurons transfer the information in a configuration that the neurons may transfer the input information to a neuron of the same layer. Recurrent neural networks (RNNs) may help to identify patterns between a plurality of input sequences, and accordingly, RNNs may identify temporal pattern provided as a time-series data and perform predictions based on the identified temporal patterns. In various examples of RNNs, long short-term memory (LSTM) architecture may be implemented. The LSTM networks may be helpful to perform classifications, and processing, and predictions using time series data.

In various examples, the neural network may be configured in top-down configuration in which a neuron of a layer provides output to a neuron of a lower layer, which may help to discriminate certain features of an input.

The AI/ML may include a reinforcement learning model. The reinforcement learning model may be modeled as a Markov decision process (MDP). The MDP may determine an action from an action set based on a previous observation which may be referred to as a state. In a next state, the MDP may determine a reward based on the next state and the previous state. The determined action may influence the probability of the MDP to move into the next state. Accordingly, the MDP may obtain a function that maps the current state to an action to be determined with the purpose of maximizing the rewards.

The AI/ML may include a trained AI/ML that is configured to provide the output as provided in various examples in this disclosure based on the input data. The trained AI/ML may be obtained via an online and/or offline training. For the offline training, a training agent may train the AI/ML based on conditions of the device including the constraints of the device, category of the device, device capabilities, etc. in a past instance of time. Furthermore, the training agent may train the AI/ML (e.g. by adjusting the machine learning model parameters stored in the memory) using online training methods based on the latest (or actual) implementation conditions, such as the location of the device, etc. Furthermore, the processor may further optimize the AI/ML based on previous inference results, and possibly based on a performance metric with respect to the previous inference results and the effects obtained in response to the previous inference results.

The training agent may train the AI/ML according to the desired outcome. The training agent may provide the training data to the AI/ML to train the AI/ML. The training data may include input data with respect to simulated operations. The training data may include training input data, generated in response to other communication activities. In various examples, the training agent may obtain the training data based on communications performed in various conditions, such as various distances to the BS, various channel qualities, various MCS assignments, etc. The training agent may store the information obtained from the transmissions performed in such conditions to obtain the training data.

The processor 500 may implement the training agent, or another entity that may be communicatively coupled to the processor 500 may include the training agent and provide the training data to the device, so that the processor 500 may train the AI/ML. In various examples, the device may include the AI/ML in a configuration that it is already trained (e.g. the machine model parameters in the memory are set). It may desirable for the AI/ML itself to have the training agent, or a portion of the training agent, in order to perform optimizations according to the output of the inferences to be performed as provided in this disclosure. The AI/ML may include an execution module and a training module that may implement the training agent as provided in this disclosure for other examples.

Furthermore, the controller 503 may control the AI/ML module 502 according to a predefined event. For example, the controller 503 may provide instructions to the AI/ML module 502 to perform the AI/ML between actual CQI measurements. For example, the device may be configured to perform periodic CQI measurements as exemplarily provided with respect to FIG. 3A. Accordingly, the device may be configured to perform a first CQI measurement (e.g. based on a first CSI-RS of periodic CSI-RSs that the BS may transmit) at a first instance of time, and the device may be configured to perform a second CQI measurement (e.g. based on a second CSI-RS of the periodic CSI-RSs that the BS may transmit) at a second instance of time. The controller 503 may control the AI/ML module 502 to predict a CQI at a third instance of time between the first instance of time and the second instance of time.

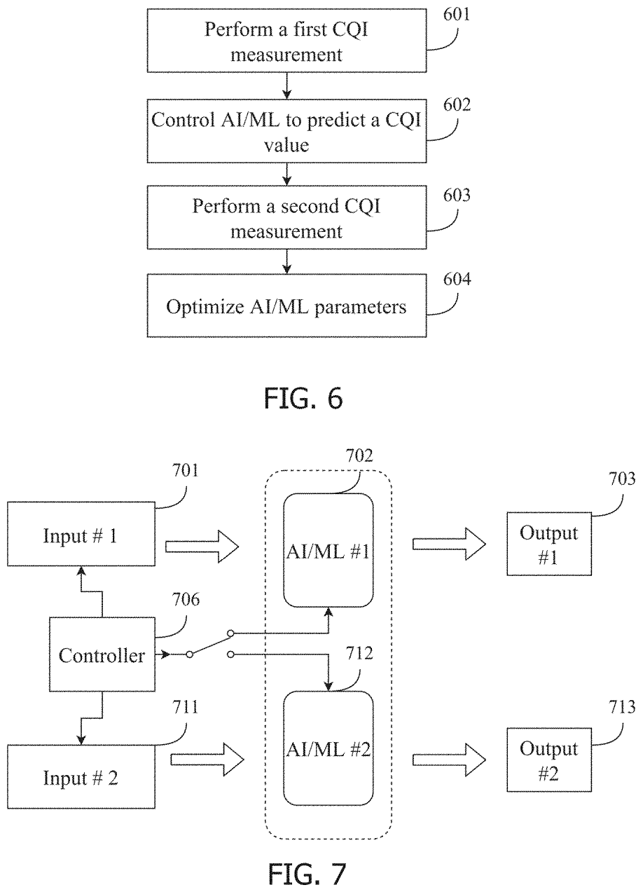

FIG. 6 exemplarily illustrates a flow diagram. The controller 503 may control the measurement circuit of the device to perform a first CQI measurement at a first instance of time. Then, the controller 503 may control the AI/ML module 502 to predict a CQI parameter in accordance with various aspects of this disclosure at a second instance of time. Then, the controller 503 may control the measurement circuit of the device to perform a second CQI measurement at a third instance of time. Then, the AI/ML module 502 may optimize the machine learning model parameters based on the predicted CQI value and at least the result of the second CQI measurement.

In various examples, representing the period of time between the first CQI measurement and the second CQI measurement as T, the controller 502 may control the AI/ML module 502 to predict the CQI parameter at a time instance at T/4, T/2, or 3T/4 period of time after the first instance of time. Furthermore, the processor 500 may include the other processing functions 504 associated with other functions of the device (e.g. baseband modem 206, application processor 212, or other one or more processors as provided with respect to FIG. 2).

Furthermore, the controller 503 may determine the context information 512 that the AI/ML module 502 receives as the input data. In various examples, the input data of the respective AI/ML may include different attributes for different configurations. For example, the AI/ML module 502 may include an AI/ML that may be configured to determine a first output based on a first input data in a first configuration, and the AI/ML module 502 may include an AI/ML that may be configured to determine a second output based on a second input data in a second configuration. The AI/ML module 502 may include a first AI/ML operating in the first configuration and a second AI/ML operating in the second configuration. The controller 503 may control the AI/ML module 502 to operate in a configuration.

FIG. 7 exemplarily shows an illustration with respect to the controller. The controller 706 may control the AI/ML module in a configuration that the AI/ML module implements a first AI/ML in a first configuration and a second AI/ML in a second configuration according to the control of the controller 706. For example, the first AI/ML 702 may be trained to predict a CQI value based on a first input 701 including the previous CQI values and the second AI/ML 712 may be trained to predict a CQI value based on a second input 711 including one or more measurement results and the context information. In various examples, the first AI/ML 702 and the second AI/ML 712 may be implemented by one AI/ML with different AI/ML parameters, and the controller 706 may determine which model parameters are to be used by the one AI/ML based on a received instruction (e.g. from other processing modules).

Accordingly, the controller 706 may also provide input data to the respective AI/ML in different configurations. The controller 706 may determine to use one of the AI/MLs 702, 712 based on availability of the data in an adaptive manner. The controller 706 may initially use the second AI/ML 712 when the device establishes a radio connection with the BS, as the device may not have previous CQI values that are specific to the radio connection. After the device obtains a number of CQI values (predicted CQI values or based on CQI measurements), the controller 706 may select the first AI/ML 702.

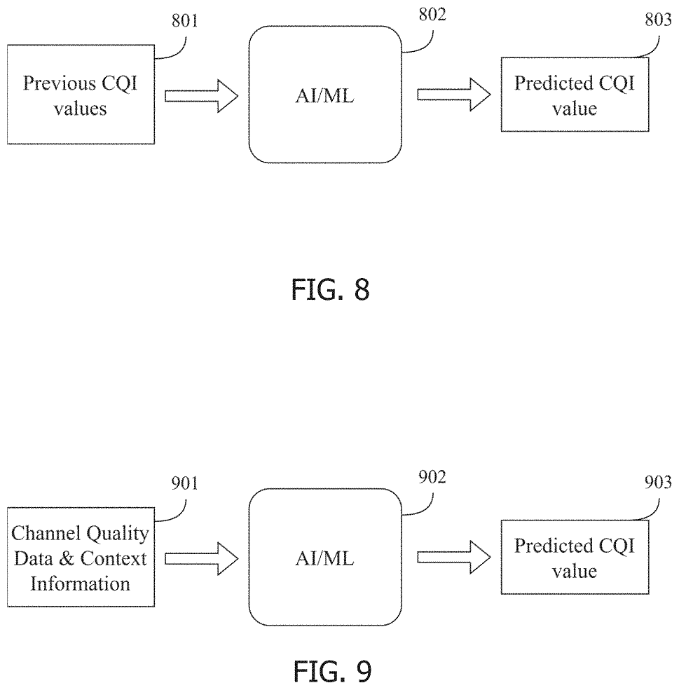

FIG. 8 shows an example of an AI/ML which the AI/ML module 502 may implement. The AI/ML 802 may be configured to receive the input data 801 and provide an output 803 indicating a predicted CQI value. The AI/ML 802 may include a trained AI/ML 802 that is configured to predict a CQI value (or provide output as provided in various examples in this disclosure) based on the input data. In this illustrative example, the input data may include a number of previous CQI values. The training of the AI/ML 802 may be obtained via an online and/or offline training. For the offline training, a training agent may train the AI/ML 802 based on conditions of the device including the constraints of the device (e.g. modulation and coding constraints), category of the device, UE capabilities, etc. in a past instance of time. Furthermore, the training agent may train the AI/ML 802 (e.g. by adjusting the machine learning model parameters stored in the memory) using online training methods based on the latest (or actual) implementation conditions, such as the location of the device, etc. Furthermore, the processor may further optimize the AI/ML 802 based on previous inference results including the predicted parameter, and possibly based on a performance metric with respect to the predicted CQI value and the radio resources configured by the BS based on the predicted CQI value (e.g. throughput of the radio communication signal, or a number of retransmissions with the configured radio settings, or received HARQ feedbacks, etc.).

In various examples, the CQI values stored in the memory may include a time-series data indicating previous CQI values for a plurality of instances of time arranged consecutively. The AI/ML 802 may include an LSTM network including a network of LSTM cells that may process the attributes provided for an instance of time from the input according to the attributes provided for the instance of time and one or more previous outputs of the LSTM that have taken in place in previous instances of time, and accordingly, obtain the output. The number of the one or more previous inputs may be defined by a window size. The window size may be arranged according to the processing, memory, and time constraints and the input data.

The LSTM network may process the features corresponding to the attributes (e.g. the previous CQI values and feature vectors obtained from the context information related to the previous CQI values as provided in this disclosure) and determine a label for each instance of time according to the features. A predictor may accordingly predict the CQI value based on the features of the window size. The predictor may predict the CQI value for one or more instances of time. The predictor may further provide an output indicating a confidence score with respect to the prediction. The skilled person would understand that the machine model parameters with respect to the LSTM (or any other examples of AI/ML as provided in this disclosure) are to be selected to give the desired performance. Such parameters may include weights and activation functions. Various metrics, including a number of retransmissions with the configured radio settings by the BS based on the predicted CQI, or information with respect to received HARQ feedbacks with the configured radio settings by the BS based on the predicted CQI, and/or such may be used to optimize the machine model parameters.

FIG. 9 exemplarily shows an illustration of an AI/ML, which the AI/ML module 502 may implement. The AI/ML 902 may be configured to receive input data 901 including the channel quality data and context information according to various aspects of this disclosure. The AI/ML 902 may be configured to provide an output 903 including a predicted CQI value based on the received input data 901. In an example, the AI/ML 902 may include a reinforcement learning model based AI/ML. A reinforcement learning agent (RL agent) may predict a CQI value based on a first state that the channel quality data and the context information represents at a first instance of time and a reward provided for the first instance of time with respect to a transition from a previous instance of time and the first instance of time. For example, the RL agent may select a CQI value from predefined CQI indices (e.g. either randomly or by selecting the CQI index with the best reward). Accordingly, the RL agent may provide an indication of the selected CQI index to a controller, and the controller may accordingly encode a message to be transmitted to the BS including the selected CQI index.

Furthermore, the RL agent may determine a reward based on the selected CQI index at the first instance time and an observation state indicated at a second instance of time. The observation state may include a state in which the BS has reconfigured radio parameters (or radio settings) in response to receiving the encoded message including the selected CQI index at the first instance of time. The RL agent may receive the reward based on at least one of a number of retransmissions during the observation state and/or a number of detected cyclic redundancy check (CRC) failures. In various examples, the RL agent may obtain the number of retransmissions and/or the number of detected CRC failures based on received HARQ feedbacks from the BS. In various examples, an observing agent may determine the reward based on the communication and provide the reward to the RL agent based on the received HARD feedbacks. Accordingly, the RL agent may obtain the capability to map the states that the channel quality data and the context information indicate to prediction of CQI values with a goal to minimize the number of retransmissions or number of HARQ/NACK feedbacks.

In one example, the RL agent may implement a Q-learning to learn the value of a predicted CQI value in the particular state according to a Q-function based on AI/ML parameters. The Q-function may be represented with an equation:

Qnew(st,at)←(1−α)Q(st,at)+α(r+γ max a(Q(st+1),a))

In the Q-function equation, s representing the state and a representing the action, indicating all state-action pairs with an index t, the new Q value of the corresponding state-action pair t is based on the old Q value for the state-action pair t and the sum of the reward r obtained by taking action at in the state st with a discount rate γ that is between 0 and 1, in which the weight between the old Q value and the reward portion is determined by the learning rate α. In this illustrative example, the observing agent may determine the reward portion based on a number of retransmissions during the observation state and/or a number of detected cyclic redundancy check (CRC) failures. During the training process, the learning rate α and the discount rate γ are to be chosen appropriately to optimize the performance.

In accordance with various aspects of this disclosure, the AI/ML may include a multi-armed bandit reinforcement learning model. In multi-armed bandit reinforcement learning models, the model may test available actions (e.g. a selection with respect to whether there is a predicted uplink transmission or not) at substantially equal frequencies. With each iteration, the AI/ML may adjust the machine learning model parameters to select actions that are leading better total returns with higher frequencies at the expense of the remaining selectable actions, resulting in a gradual decrease with respect to selection frequency of the remaining selectable actions, and possibly replace the actions that are gradually decreased with other selectable actions. In various examples, the multi-armed bandit RL model may select the actions irrespective of the information representing the state. The multi-armed RL model may also be referred as one-state RL, as it may be independent from the state. Accordingly, with respect to examples provided in this section, the AI/ML may include a multi-armed bandit reinforcement learning model configured to select actions without any information indicating the state.

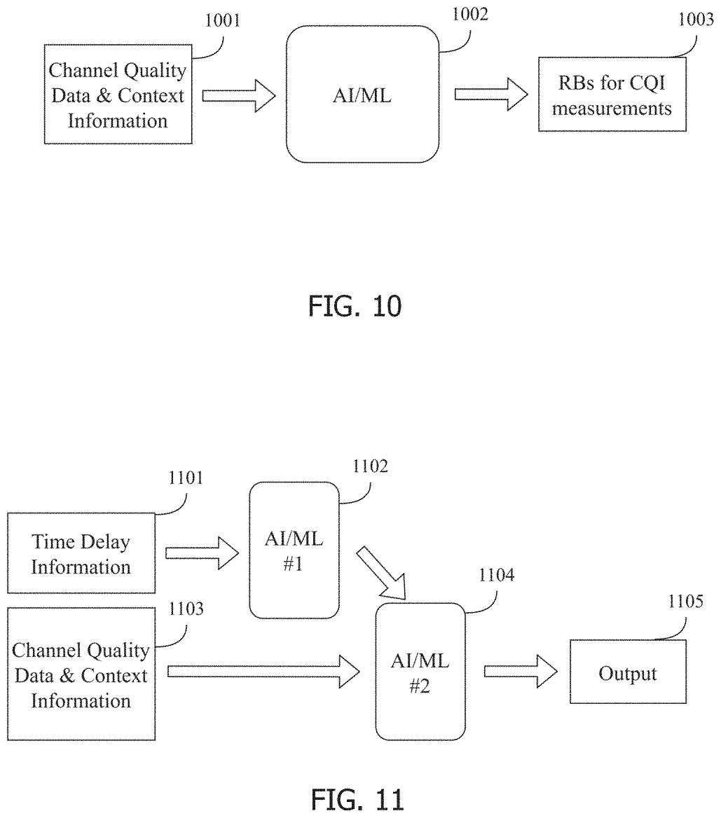

FIG. 10 exemplarily shows an illustration with respect to an AI/ML, which the AI/ML module 502 may implement. The AI/ML 1002 may be configured to receive the input data 1001 and provide an output 1003 indicating resource blocks to perform CQI measurements. The AI/ML 1002 may include a trained AI/ML that is configured to predict the resource blocks to perform CQI measurements based on the input data. CQI measurements may include various types of operations including averaging, filtering, interpolating/extrapolating, transformations, matrix computations for a resource block in both frequency and time domain. Principally, such measurements can be performed over a fixed time and frequency window. The output of the AI/ML 1002 may be desirable with an intention to set the window size in an adaptive manner.

In this illustrative example, the input data may include, in particular, the channel quality data including measurements of the channel (e.g. IQ samples, FFT samples, or preprocessed measurements), and the context information including, in particular, the location information of the device, such as the mobility of the device (whether the device is at a fixed location or mobile), velocity, and moving direction. Based on the output of the AI/ML 1002 a controller may determine a window size for the measurements and perform measurements over the predicted resource blocks.

FIG. 11 exemplarily shows an illustration with respect to AI/MLs, which the AI/ML module 502 may implement. In this illustrative example, the AI/ML module may include a first AI/ML 1102 and a second AI/ML 1104. The first AI/ML 1102 that may be configured to receive input data 1101 including time delay information and determine a time delay indicating a period of time between a generation of a CQI value at the device and a configuration of radio settings by a BS in response to a received message including the generated CQI value. The time delay information may include at least one of a first instance of time of a generation of at least one previous CQI, a second instance of time of a transmission of information comprising an indication of the at least one previous CQI, or a third instance of time of a downlink communication scheduled in response to the at least one previous CQI, or a predetermined time gap information representing a period of time between a generation of the channel quality information and a reception of the generated channel quality information by the BS.

The second AI/ML 1104 may be configured to receive an input data 1103 including the channel quality data and the context information. The second AI/ML 1104 may further be configured to receive information indicating the determined time delay by the first AI/ML 1102. The second AI/ML 1104 may be configured to provide an output 1105 including a predicted CQI value for an instance of time based on the determined time delay. In various examples, the second AI/ML 1104 may be configured to provide the output 1105 including a predicted CQI value for an instance of time that is after the current time by the determined time delay.

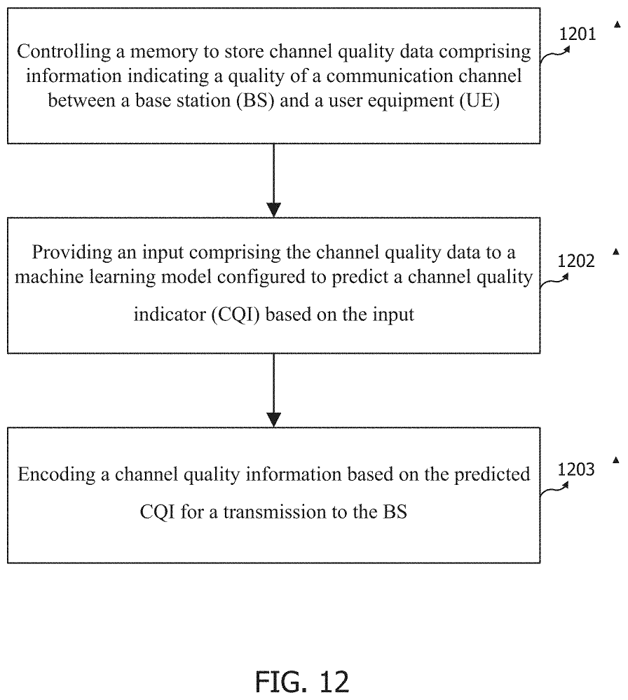

FIG. 12 shows an example of a method. The method may include controlling 1202 a memory to store channel quality data comprising information indicating a quality of a communication channel between a base station (BS) and a user equipment (UE), providing 1202 an input comprising the channel quality data to a machine learning model configured to predict a channel quality indicator (CQI) based on the input, encoding 1203 a channel quality information based on the predicted CQI for a transmission to the BS. A non-transitory computer-readable medium may include one or more instructions which, when executed by a processor, to perform the method.

Once a BS receives an uplink feedback information such as a CQI from a terminal device (e.g. UE), the BS may configure radio resources for the terminal device based on the received CQI along with the downlink data coming to the BS from the core network to schedule and allocate resources. The BS may determine the sub-frame that is going to be scheduled for uplink or downlink in a TDD case, perform user selection in a multi-user environment, allocate physical resources such as physical resource block (PRB) selection or allocation, select a modulation and coding scheme (MCS) for the terminal device, and determine a transmit power for the terminal devices. As provided in this disclosure, terminal devices may provide information indicating the CQIs to the BS. It may be desirable for the BS to predict a CQI for a communication channel between the BS and the terminal device to manage and configure radio resources for the terminal device.

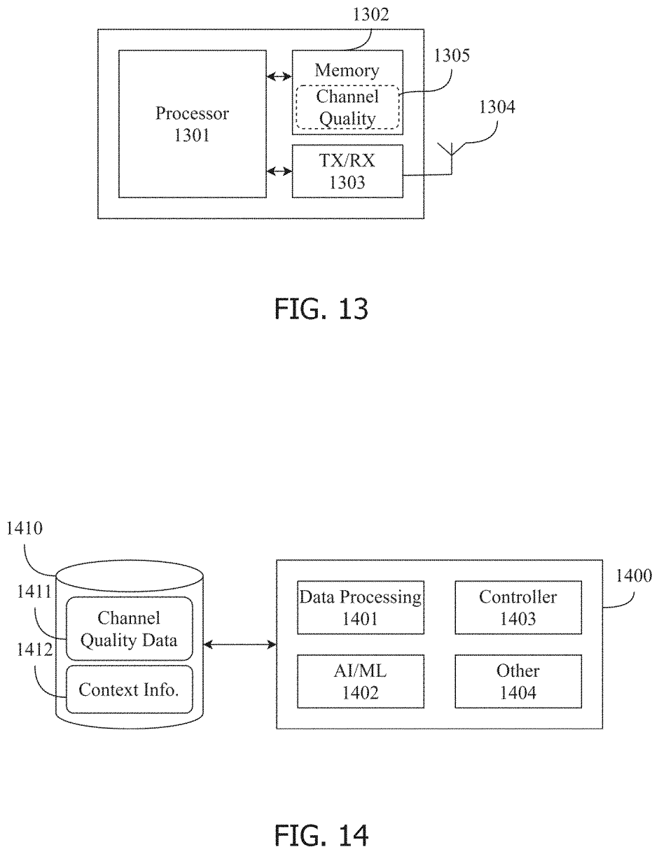

FIG. 13 shows an example of a device according to various examples in this disclosure. The device is depicted as a radio communication device in this illustrative example, comprising a processor 1301, a memory 1302, and a transceiver 1303 configured to receive and transmit radio communication signals using an antenna element 1304. In one example, a BS may include the device. The illustration depicts that there is one antenna element coupled to the transceiver 1303, however, this should not be considered as limiting, and the radio communication device may be coupled to any number of antenna elements. The transceiver 1303 may include a plurality of antenna ports couplable to a plurality of antenna elements. The processor 1301 may include one or more processors which may include a baseband processor and an application processor.

The memory 1302 may be configured to store channel quality data 1305 including one or more measurement results indicating measurements of received radio communication signals from another device, such as other terminal devices in the radio communication network. In various examples, the radio communication signals may include uplink radio communication signals received by a BS from UEs. The device may include a measurement circuit to measure the received radio communication signals to obtain the one or more measurement results. The transceiver 1303 may include the measurement circuit according to the configuration of the device in which the measurement circuit may measure the received uplink radio communication signals and/or the received downlink radio communication signals.

The measurement circuit may measure the received radio communication signals based on in-phase and quadrature samples (IQ samples). Accordingly, the one or more measurement results may include information (e.g. power) of the IQ samples for one or more received radio communication signals. The measurement circuit may generate a plurality of fast Fourier transform (FFT) sample values based on the received radio communication signals. Accordingly, the one or more measurement results may include information of the plurality of FFT samples of on one or more received radio communication signals. The measurement circuit may measure power of a received radio communication signal over a defined bandwidth, and the processor 1301 may obtain reference signal received power (RSRP), a received signal strength indicator (RSSI), or reference signal received quality (RSRQ) values based on the measured power. Accordingly, the one or more measurement results may include RSRPs, RSSIs, and/or RSRQs, or any other forms of processed signals. Furthermore, the channel quality data 1305 may include a plurality of received CQI values from one or more UEs.

The channel quality data 1305 may include channel measurements based on uplink reference signals. In a TDD configuration, channel measurements based on uplink reference signals may provide an insight with respect to the quality of a communication channel. Furthermore, the channel quality data 1305 may further include information indicating the separation of frequency resources in terms of uplink and downlink.

The processor 1301 may predict a channel quality indicator parameter based on the channel quality data 1305 using a trained machine learning model. The processor 1301 may provide the channel quality data 1305 to an input of a trained artificial intelligence/machine learning model (AI/ML). The AI/ML may be configured to provide an output including a resource management parameter which the processor 1301 may use to manage and configure radio resources for a UE based on the input of the AI/ML. In various examples, the resource management parameter may include a predicted CQI index for the UE. The processor 1301 may implement the AI/ML based on a plurality of machine model parameters stored in the memory, or provide the channel quality data 1305 to an external processor or an external computing device that is configured to implement the AI/ML as provided in this disclosure. The processor 1301 may include an accelerator or a neuromorphic processor to implement the AI/ML.

Furthermore, the processor 1301 may perform various functions with respect to the device including any type of functions that a BS may perform based on 3GPP standards with respect to LTE or 5G NR. Especially with respect to various aspects of this disclosure, the processor 1301 may configure uplink or downlink radio resources for each UE that the BS is communicatively coupled to. In particular, the processor 1301 may be configured to allocate and schedule time and frequency resources for each UEs in the cell in which UEs may transmit and/or receive radio communication signals, determine MCS parameters for each UE in the cell to use, perform user-selections in a multi-user environment, provide a closed-loop power control for each UE to control their transmit powers, etc.

In various examples, the memory 1302 may further store context information including information representing a plurality of attributes with respect to the device and the radio connection between the device and the other communication device. The context information may include attributes in which the device performed the one or more measurements, or attributes in which the device operates in an established radio connection with the other communication device.

The processor 1301 may generate the context information according to operations of the device when the device is connected to the other communication device over the radio connection. The processor 1301 may access the required information for the context information through various sources, such as RRC configuration messages exchanged between the BS and the UE, Medium Access Layer (MAC) information exchanged between the BS and the UE, UE information that is stored in a memory (e.g. the memory 1302), etc. The processor 1301 may access the information that is stored in the memory 1302 for other operations to obtain the information with respect to the context information when it is desired and perform operations as provided in this disclosure. At least for the context information that the processor 1301 may generate, the processor 1301 may further store time information for the respective attribute. The time information may indicate the instance of time that the processor 1301 has generated the respective portion of the context information, or the instance of time that the processor 1301 respective portion of the context information relates to. Furthermore, once the respective AI/ML provides an output, the processor 1301 may perform various actions with respect to the output of the AI/ML.

FIG. 14 shows an example of a processor and a memory of a device according to various aspects provided in this disclosure. The processor 1400 is depicted to include various functional modules that are configured to provide various functions respectively. The skilled person would recognize that the depicted functional modules are provided to explain various operations that the processor 1400 may be configured to. Similarly, the memory 1410 is depicted to include the channel quality data 1411 and the context information 1412 as blocks, however, the memory may store the channel quality data 1411 and the context information 1412 in any kind of configuration, which may further be provided in this disclosure in various examples. Furthermore, the AI/ML 1402 is depicted as it is implemented in the processor 1400 only as an example, and any type of AI/ML implementations which may include the implementation of the AI/ML in an external processor, such as an accelerator, a graphics processing unit (GPU), a neuromorphic chip, or in a cloud computing device, or in a memory (e.g. the memory 1410) may also be possible according to any methods.

The processor 1400 may include a data processing module 1401 that is configured to process the data and generate at least a portion of the channel quality data 1411 and/or the context information 1412 as provided in various examples in this disclosure. In various examples, the channel quality data 1411 and the context information 1412 may include information for the past operations that the device has performed in the past for at least within a period of time in a plurality of instances of time. The data processing module 1401 may generate a portion of the channel quality data 1411 and the context information 1412 according to the operations of the device. The channel quality data 1411 may include one measurement result (e.g. the latest measurement result) along with the context information 1412.

As an example, the data processing module 1401 may track uplink channel measurements that a measurement circuit may perform and store the results of the measurements as the measurements results 1411. Furthermore, the data processing module 1401 may access information directly for a portion of context information 1412 that is already stored in the memory 1410 for operations of other entities. For example, the memory 1410 may include already the information related to the BS (e.g. cell loading of the BS, etc.) for other operations, so the data processing module 1401 may not generate the same information to regard that particular information as the context information 1412. The data processing module 1401 may obtain the information to be used as the context information 1412 based on exchanged messages between the BS and the UE. The data processing module 1401 may obtain various information from messages received from the BS.

The context information 1412 may include information with respect to a plurality of attributes about the device and activities of the device. The context information 1412 may include information which the AI/ML 1402 may use to determine the resource management parameter, especially to predict a CQI index for a UE to be used for the radio communication between the device and the UE.

For example, the context information 1412 may include a received requests of resources from the UE. Such requests of resources may also include request of uplink channels. Requests of resources may further include information indicating traffic needs of the UE. Such requests may indicate traffic needs for the UE in which the B S may take under consideration to configure radio resources for the UE. In various examples, the context information 1412 may further include requests of resources of other UEs that are communicatively coupled to the BS. One exemplary request of resources include a buffer status report.

Furthermore, the context information 1412 may include parameters with respect to quality of service (QoS) requirements and/or constraints for received uplink data from the UE. In various examples, the processor 1400 (e.g. other processing functions 1404) may determine the QoS parameters for received data based on assigned QoS parameters to one or more QoS flows received from the UE. The processor 1400 may determine the QoS parameters based on any information indicating a kind of priority with respect to received QoS flows. QoS parameters of the QoS flows may include a 5G QoS identifier (5QI) or an allocation and retention priority (ARP). In various examples, the processor 1400 may store QoS needs (e.g. QoS parameters based on received uplink data) for one or more other UEs that are communicatively coupled to the BS as the context information 1412.

Furthermore, the context information 1412 may include detected interference on the communication channel between the UE and the BS. The context information 1412 may further include detected interference at the cell sector that the BS serves. In various examples, the process 1400 (e.g. other processing functions 1404) may generate information indicating the interferences as provided in this disclosure based on uplink channel measurements. Furthermore, the context information 1412 may include a cell load parameter indicating the load of the cell sector that the BS serves. Furthermore, the context information 1412 may include frequency separation between uplink and downlink as well.

The AI/ML module 1402 may implement the AI/ML. The AI/ML module 1402 may include similar operations and functions as provided with respect to the AI/ML module 502. The AI/ML module 1402 may implement an AI/ML which the details of are provided according to the AI/ML module 502 and will not be repeated here. The controller 1403 and the other processing functions 1404 may also function in a similar manner to the processor 500.

For example, the controller 1403 may control the AI/ML module 1402 according to a predefined event as provided with respect to FIG. 5. For example, the controller 1403 may provide instructions to the AI/ML module 1402 to perform the AI/ML between received CQI measurements from the UE. For example, the device may be configured to receive periodic CQI measurements from the UE. Accordingly, the device may be configured to receive a first CQI (e.g. based on a first CSI-RS of periodic CSI-RSs that the BS may transmit) at a first instance of time, and the device may be configured to receive a second CQI (e.g. based on a second CSI-RS of the periodic CSI-RSs that the BS may transmit) at a second instance of time. The controller 1403 may control the AI/ML module 1402 to predict a CQI for the UE at a third instance of time between the first instance of time and the second instance of time.

In various examples, representing the period of time between the first received CQI from the UE and the second received CQI from the UE as T, the controller 1402 may control the AI/ML module 1402 to predict a CQI index for the UE at a time instance at T/4, T/2, or 3T/4 period of time after the first instance of time. Accordingly, the processor 1400 (e.g. other processing functions 1404) may configure radio resources for the UE based on the predicted CQI index, in a manner that is similar with a received CQI index from the UE. It may be desirable to use the predicted CQI index for the UE with an intention to improve user selection and scheduling.

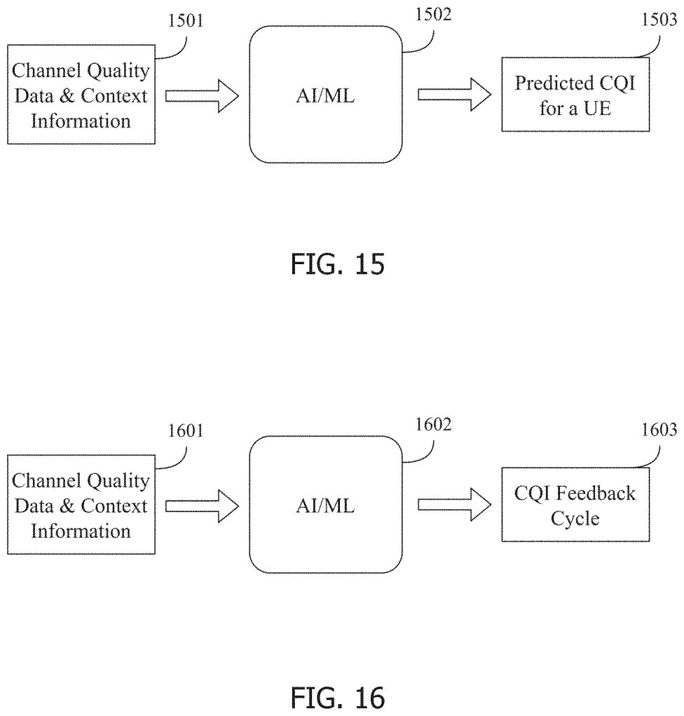

FIG. 15 shows an example of an AI/ML which the AI/ML module 1402 may implement. The AI/ML 1502 may be configured to receive the input data 1501 and provide an output 1503 indicating a predicted CQI value for a UE. The AI/ML 1502 may include a trained AI/ML 1502 that is configured to predict a CQI value for the UE based on the input data 1501. In this illustrative example, the input data may include the channel quality data including received CQI values from the UE and uplink channel measurements. Furthermore, the input data 1501 may also include the context information as provided in accordance with this disclosure.

The trained AI/ML 1502 may be obtained via an online and/or offline training. For the offline training, a training agent may train the AI/ML 1502 based on conditions of the device including the constraints of the device (e.g. cell capacity), BS capabilities, etc. in a past instance of time. Furthermore, the training agent may train the AI/ML 1502 (e.g. by adjusting the machine learning model parameters stored in the memory) using online training methods based on the latest (or actual) implementation conditions, such as the location of the BS, interference, cell load conditions, etc. Furthermore, the processor may further optimize the AI/ML 1502 based on previous inference results including the determined resource management parameter, which includes the predicted CQI value for the UE for this illustrative example, and possibly based on a performance metric with respect to the predicted CQI value and the configured radio resources based on the predicted CQI value for the UE.

The AI/ML 1502 may include an LSTM network or a reinforcement learning model as exemplarily provided with respect to FIG. 8 and FIG. 9, and the AI/ML may perform similar operations as provided in respective sections. With respect to the LSTM network, the input data 1501 may include a time-series data and the AI/ML 1502 may be further configured to optimize the machine learning model parameters based on a number of retransmissions performed by the UE with configured radio resources based on the predicted CQI value for the UE, or a number of CRC failures with respect to received radio communication signals from the UE with the configured radio resources. In various examples, the processor may determine the number of retransmissions or CRC failures based on a number of HARQ/NACK messages that the processor has encoded for a transmission to the UE.

With respect to the reinforcement learning model application of the AI/ML 1502, the AI/ML 1502 may determine rewards for observation states based on at least data error rate, a number of retransmissions performed by the UE with configured radio resources based on the predicted CQI value for the UE, a number of CRC failures with respect to received radio communication signals from the UE with the configured radio resources, or a received buffer status report from the UE indicating an amount of data scheduled for transmission to the BS. In various examples, the processor may determine the number of retransmissions or CRC failures based on a number of HARQ/NACK messages that the processor has encoded for a transmission to the UE.

FIG. 16 exemplarily shows an illustration of an AI/ML, which the AI/ML module 1402 may implement. The AI/ML 1602 may be configured to receive the input data 1601 and provide an output 1603 indicating a determined CQI feedback cycle value as the resource management parameter. The AI/ML 1602 may include a trained AI/ML 1602 that is configured to determine a CQI feedback cycle value on the input data 1601. In this illustrative example, the input data may include the channel quality data including received CQI values from the UE and uplink channel measurements. Furthermore, the input data 1601 may also include the context information as provided in accordance with this disclosure.

In various examples, the AI/ML 1602 may be configured to provide the determined CQI feedback cycle value for an application of all over the cell that the BS may serve (i.e. for all UEs). The AI/ML 1602 may be configured to provide the determined CQI feedback cycle value for the application of the UE. It may be desirable to implement an adaptive determination for the CQI feedback cycle value, since a CQI feedback cycle value indicating relatively frequent CQI feedbacks may increase the overhead at the control channel. Especially, in scenarios which the number of users in the cell is relatively high, the uplink capacity may be limited. In such cases, an increased CQI feedback cycle value (less frequent CQI feedbacks) may help the BS to reduce the load at the uplink. Accordingly, based on the determination of the CQI feedback cycle value, the processor may encode messages indicating the determined CQI feedback cycle values to the UE (or UEs).

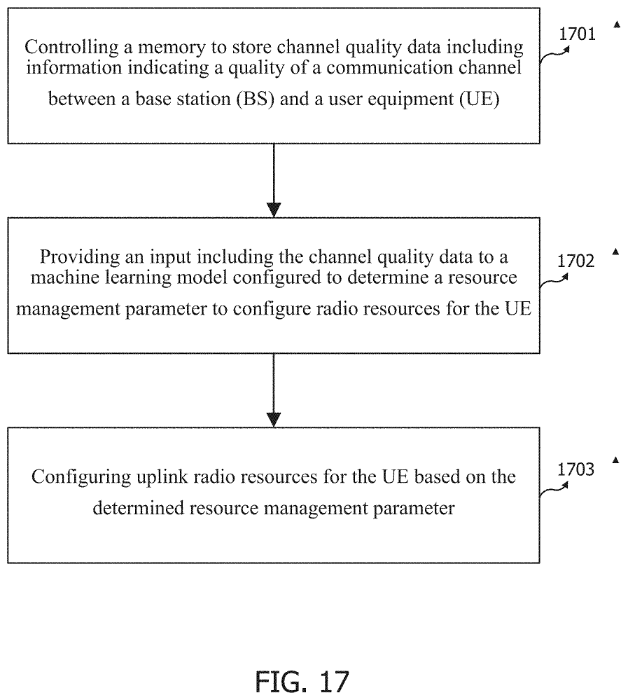

FIG. 17 shows an example of a method. The method may include controlling 1701 a memory to store channel quality data including information indicating a quality of a communication channel between a base station (BS) and a user equipment (UE), providing 1702 an input including the channel quality data to a machine learning model configured to determine a resource management parameter to configure radio resources for the UE, and configuring 1703 uplink radio resources for the UE based on the determined resource management parameter. A non-transitory computer-readable medium including one or more instructions which, if executed by a processor, cause the processor to perform the method.

Another parameter that a BS may use to configure radio resources for a UE may include scheduling requests (SRs) buffer status reports (BSRs). Traditionally, a UE may transmit an SR in uplink in order to request from a BS physical uplink shared channel (PUSCH) or physical uplink control channel (PUCCH) resources for transmitting data. The UE may transmit the SR via PUCCH. In response to a received SR, the BS may allocate resources (i.e. uplink grant) for the UE and provide an indication of the uplink grant over the physical downlink control channel (PDCCH) to the UE. Furthermore, the UE may transmit BSRs to the BS indicating the amount of data that the UE intends to transmit, so that the BS may allocate necessary resources for the UE. The exchange of information may introduce latency for the applications and also overhead for the control channel. It may be desirable to perform predictions with respect to data to be scheduled for transmission with an intention to obtain allocated resources to transmit data at an optimal time. It may be further desirable to reduce potential delays with respect to sending a BSR and receiving resources needed to transmit the uplink data.

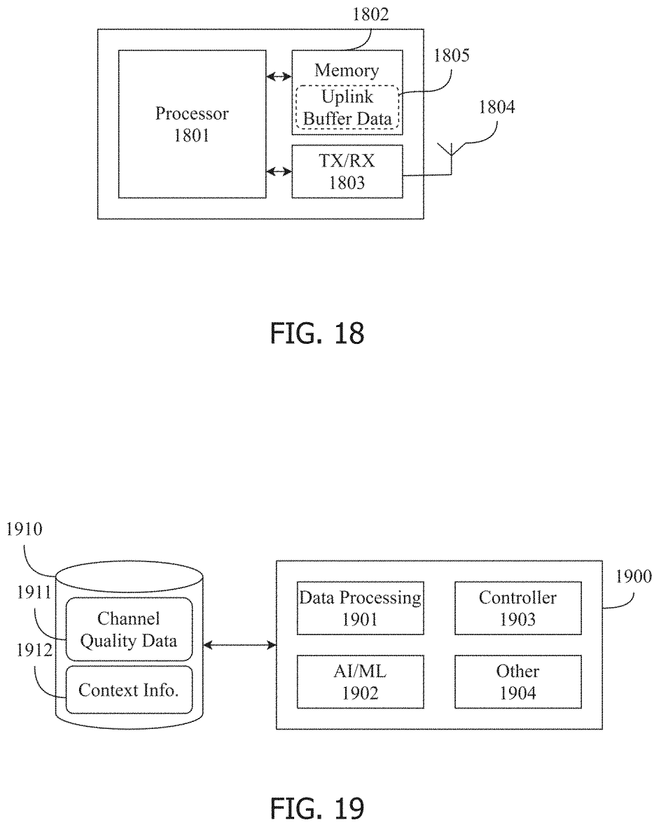

FIG. 18 shows an example of a device according to various examples in this disclosure. The device is depicted as a radio communication device in this illustrative example, comprising a processor 1801, a memory 1802, and a transceiver 1803 configured to receive and transmit radio communication signals using an antenna element 1804. In one example, a UE may include the device. The illustration depicts that there is one antenna element coupled to the transceiver 1803, however, this should not be considered as limiting, and the radio communication device may be coupled to any number of antenna elements. The transceiver 1803 may include a plurality of antenna ports couplable to a plurality of antenna elements. The processor 1801 may include one or more processors which may include a baseband processor and an application processor. The processor 1801 may be configured to perform various layer functions of a network stack to perform communication functions based on a communication reference model, such as open systems interconnection (OSI) model.

The memory 1802 may include a buffer memory in which various layer functions that the processor 1801 may perform can access and store data. The processor 1801 may perform radio link control (RLC) layer functions to receive and/or send data units (DUs) from upper layers to lower layers of the network stack. The processor 1801 may perform RLC functions in various modes, and one of the functions that the processor 1801 may perform as RLC functions includes buffering the data scheduled for transmission at the device. The processor 1801 may use the memory to store the data scheduled from transmission in the buffer memory.

The processor 1801 may generate a BSR to be transmitted for a BS based on a data volume calculation in which the processor 1801 may include the amount of data in an uplink buffer including RLC service data units (SDUs) and RLC SDU segments that have not yet been included in an RLC data protocol data unit (PDU), RLC data PDUs that are pending for initial transmission, and RLC data PDUs that are pending for retransmission (RLC Acknowledge Mode (AM)). Accordingly, the processor 1801 may be configured to determine amount of data in RLC buffers, which may be referred to as “RLC buffer length” in this disclosure.

The memory 1802 may be further configured to store uplink buffer data 1805 including information indicating one or more past states of the uplink buffer of the device. In various examples, the uplink buffer data 1805 may include previous buffer size information that the device has transmitted to a BS via a plurality of previously generated BSRs. The uplink buffer data 1805 may include further information with respect to the RLC buffer length, such as information indicating the amount of data for each of i) RLC service data units (SDUs) and RLC SDU segments that have not yet been included in an RLC data protocol data unit (PDU), ii) RLC data PDUs that are pending for initial transmission, and iii) RLC data PDUs that are pending for retransmission (RLC Acknowledge Mode (AM)). The uplink buffer data 1805 may include information indicating an amount of data scheduled for transmission to the BS.

The processor 1801 may monitor the uplink buffer to obtain the uplink buffer data 1805. The uplink buffer data 1805 may further include information indicating an amount of data that the uplink buffer has received in a period of time for a plurality of periods of time. The processor 1801 may store the uplink buffer data 1805 in the memory in a time-series data configuration. The uplink buffer data 1805 may further include information indicating an arrival time for the data arriving at the uplink buffer. The uplink buffer data 1805 may further include information indicating the sizes of the packets arrived at the uplink buffer.

The processor 1801 may predict an uplink transmission to be transmitted to the BS based on the uplink buffer data 1805 using a trained machine learning model. The processor 1801 may provide the uplink buffer data 1805 to an input of a trained artificial intelligence/machine learning model (AI/ML). The AI/ML may be configured to provide an output including a predicted uplink transmission to the BS which the processor 1801 may use to send an SR indicating the predicted uplink transmission to the BS.

The processor 1801 may periodically provide the input data to the AI/ML. Based on a received output of the AI/ML indicating a predicted uplink transmission to the BS, the processor 1801 may send an SR to the BS to request a channel grant. The processor 1801 may determine whether the device has a granted uplink channel in response to the received output of the AI/ML indicating the predicted uplink transmission to the BS, and the processor 1801 may send an SR to the BS in case the device has no granted uplink channel. The processor 1801 may accordingly encode a message including an SR to request an uplink channel based on the predicted uplink transmission to be transmitted to the BS.

The predicted uplink transmission to the BS may include an SR to be transmitted to the BS. The processor 1801 may implement the AI/ML based on a plurality of machine model parameters stored in the memory 1802, or provide the uplink buffer data 1805 to an external processor or an external computing device that is configured to implement the AI/ML as provided in this disclosure. The processor 1801 may include an accelerator or a neuromorphic processor to implement the AI/ML.

In various examples, the memory 1802 may further store context information including information representing a plurality of attributes with respect to the device and the radio connection between the device and the BS. The context information may include attributes in which the device performed the one or more measurements, or attributes in which the device operates in an established radio connection with the other communication device.

The processor 1801 may generate the context information according to operations of the device when the device is connected to the other communication device over the radio connection. The processor 1801 may access the required information for the context information through various sources, such as RRC configuration messages exchanged between the BS and the UE, Medium Access Layer (MAC) information exchanged between the BS and the UE, UE information that is stored in a memory (e.g. the memory 1802), etc. The processor 1801 may access the information that is stored in the memory 1802 for other operations to obtain the information with respect to the context information when it is desired and perform operations as provided in this disclosure. At least for the context information that the processor 1801 may generate, the processor 1801 may further store time information for the respective attribute. The time information may indicate the instance of time that the processor 1801 has generated the respective portion of the context information, or the instance of time that the processor 1801 respective portion of the context information relates to. Furthermore, once the respective AI/ML provides an output, the processor 1801 may perform various actions with respect to the output of the AI/ML.

FIG. 19 shows an example of a processor and a memory of a device according to various aspects provided in this disclosure. The processor 1900 is depicted to include various functional modules that are configured to provide various functions respectively. The skilled person would recognize that the depicted functional modules are provided to explain various operations that the processor 1900 may be configured to. Similarly, the memory 1910 is depicted to include the uplink buffer data 1911 and the context information 1912 as blocks, however, the memory may store the channel quality data 1911 and the context information 1912 in any kind of configuration, which may further be provided in this disclosure in various examples. Furthermore, the AI/ML 1902 is depicted as it is implemented in the processor 1900 only as an example, and any type of AI/ML implementations which may include the implementation of the AI/ML in an external processor, such as an accelerator, a graphics processing unit (GPU), a neuromorphic chip, or in a cloud computing device, or in a memory (e.g. the memory 1910) may also be possible according to any methods.

The processor 1900 may include a data processing module 1901 that is configured to process the data and generate at least a portion of the uplink buffer data 1911 and/or the context information 1912 as provided in various examples in this disclosure. The uplink buffer data 1911 and the context information 1912 may include information for the past operations that the device has performed in the past for at least within a period of time in a plurality of instances of time. The data processing module 1901 may generate a portion of the uplink buffer data 1911 and the context information 1912 according to the operations of the device. The uplink buffer data 1911 may include uplink buffer information as provided in this disclosure along with the context information 1912.

As an example, the data processing module 1901 may monitor uplink buffers store information with respect to the amount of data in the uplink buffers as the uplink buffer data 1911. Furthermore, the data processing module 1901 may access information directly for a portion of context information 1912 that is already stored in the memory 1910 for operations of other entities. For example, the memory 1910 may include already the information related to the device for other operations, so the data processing module 1901 may not generate the same information to regard that particular information as the context information 1912. The data processing module 1901 may obtain the information to be used as the context information 1912 based on exchanged messages between the BS and the UE. The data processing module 1901 may obtain various information from messages received from the BS.

Furthermore, the data processing module 1901 may include functions to communicate with application layer functions that the processor 1900 may perform. As indicated one of the examples, the device may be a UE and the device may run various applications in the application layer sending or receiving data from lower layers of the protocol stack. The data processing module 1901 may obtain information related to the applications (e.g. application information), in particular running applications from the memory 1910. The data processing module 1901 may receive information indicating types of the running applications, QoS requirements of the running applications, application identifiers, etc.

Furthermore, at least some of the running applications may provide information about an anticipation of a prediction of the amount of data to be used in a network traffic. The data processing module 1901 may receive information indicating the anticipated or predicted amount of data from running applications. The anticipated or predicted amount of data may include an amount for uplink traffic, an amount for downlink traffic, or a total amount. The data processing module 1901 may operate in another layer of the protocol stack, and the data processing module 1901 may send requests for information and receive the application information by exchanging cross-layer information with the application layer. The data processing module 1901 may store the application information as a portion of the context information 1912 in the memory 1910.

The context information 1912 may include information with respect to a plurality of attributes about the device and activities of the device. The context information 1912 may include information which the AI/ML 1902 may use to predict an uplink transmission to be transmitted to the BS, and/or predict an amount of data to be scheduled for uplink transmission. The context information 1912 may include information in a time-series configuration for a plurality of instances of time.

The context information 1912, may accordingly include application information indicating running applications, types of the running applications, QoS requirements of the running applications, and predicted amount of data with respect to the network traffic. The context information 1912 may include parameters with respect to quality of service (QoS) requirements and/or constraints for data scheduled for transmission or transmitted to the BS. In various examples, the processor 1900 may determine the QoS parameters for data based on assigned QoS parameters to one or more QoS flows that the device may transmit. The processor 1900 may determine the QoS parameters based on any information indicating a kind of priority with respect to received QoS flows. QoS parameters of the QoS flows may include a 5G QoS identifier (5QI) or an allocation and retention priority (ARP).

The network characteristics or expected network measures may be represented by Quality of Services (QoS) requirements with respect to the respective application, or Quality of Experience (QoE) requirements with respect to the respective application, a further quality score for the respective application, or a latency tolerance of the application. Further categories that may define the latency tolerance or other perceptual measures that the applications may provide may further be used. Such information may provide an insight with respect to the resources that the applications may need during their operation and accordingly, may affect the prediction of the communication activity.

In various examples, the data processing module 1901 may obtain these measures from an application layer entity providing functions at the application layer according to the open systems interconnection (OSI) model. In some examples, the processor 1900 may obtain these measures based on QoS parameters (e.g. 5QI for 5G) with respect to the scheduled or transmitted QoS flows in lower layers. For any of these operations, the application data may also include the information indicating the running applications, as the QoS requirements may be directly indicated by the running applications.

Furthermore, the context information 1912 may include information with respect to received downlink data at least for a period of time, or for a plurality of periods of time. The data processing module 1901 may monitor the downlink network traffic with respect to radio communication signals that the device may receive and store information with respect to received downlink data, such as the amount of data received at a period of time, type of received data, the amount of data received related to the running applications and such.

The AI/ML module 1902 may implement the AI/ML. The AI/ML module 1902 may include similar operations and functions as provided with respect to the AI/ML module 502. The AI/ML module 1902 may implement an AI/ML which the details of are provided according to the AI/ML module 502 and will not be repeated here. The controller 1903 and the other processing functions 1904 may also function in a similar manner to the processor 500.

For example, the controller 1903 may control the AI/ML module 1902 according to a predefined event as provided with respect to FIG. 5. For example, the controller 1903 may provide instructions to the AI/ML module 1902 to operate a first AI/ML configured to predict the uplink transmission to be transmitted to the BS based on the input data including the uplink buffer data 1911 and the context information 1912. Once the first AI/ML provides an output indicating that there is a predicted uplink transmission to be transmitted to the BS based on the input data, the controller 1903 may provide instructions to the AI/ML module 1902 to operate a second AI/ML mode configured to predict an amount of data to be scheduled for uplink transmission based on the input data including the uplink buffer data 1911 and the context information.

The controller 1903 may further access information indicating whether the device has a granted uplink communication channel, and the controller 1903 may provide instructions to the AI/ML module 1902 in a similar manner to operate either the first AI/ML when there is no granted uplink communication channel, or when there is no granted uplink communication channel of a desired channel type, or the second AI/ML when there is a granted uplink communication channel, or there is a granted uplink communication channel of the desired channel type.

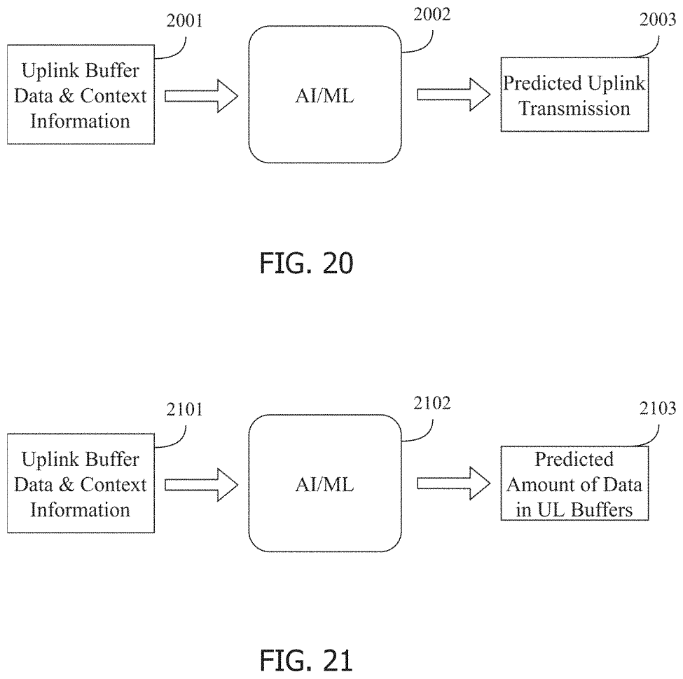

FIG. 20 shows an example of an AI/ML which the AI/ML module 1902 may implement. The AI/ML 2002 may be configured to receive the input data 2001 and provide an output 2003 indicating a predicted uplink transmission. The AI/ML 2002 may include a trained AI/ML 2002 that is configured to predict uplink transmissions for a UE based on the input data 2001. In this illustrative example, the input data 2001 may include the uplink buffer data. Furthermore, the input data 2001 may also include the context information as provided in accordance with this disclosure.

The output 2003 of the AI/ML 2002 may include information indicating whether there is a predicted uplink transmission for the device, or not (e.g. a binary value). The output 2003 may include information indicating whether there is a predicted uplink transmission for the device to the BS at a specific instance of time. The AI/ML 2002 may be configured to provide predictions with respect to a predefined amount of time later than the current time. The output 2003 may include information indicating a time for the predicted uplink transmission to the BS. The output 2003 may include an SR. The output 2003 may further include a prediction with respect to the amount of data for the predicted uplink transmission to the BS. The output 2003 may further include information indicating a confidence score for the prediction.

Based on the output 2003, the processor 1900 of the device may send an SR to the BS to request an uplink channel from the BS. The processor 1900 may further encode message including a BSR based on the amount of data scheduled for transmission in the uplink buffers to be transmitted to the BS based on the output 2003, for example after a predefined period of time in response to an output indicating the predicted uplink transmission. Furthermore, the processor 1900 may encode a message including a BSR based on the predicted amount of data in the uplink buffers for the predicted uplink transmission. The encoded message may include a MAC control element (MAC CE) indicating the amount of the data.

The trained AI/ML 2002 may be obtained via an online and/or offline training. For the offline training, a training agent may train the AI/ML 2002 based on conditions of the device including the constraints of the device (e.g. UE category), UE capabilities, etc. in a past instance of time with a target to obtain the outputs as provided with respect to this example. Furthermore, the training agent may train the AI/ML 2002 (e.g. by adjusting the machine learning model parameters stored in the memory) using online training methods based on the latest (or actual) implementation conditions, such as running applications, downlink data receptions, etc. Furthermore, the processor may further optimize the AI/ML 2002 based on previous inference results including the predicted uplink transmission, and possibly based on a performance metric with respect to the predicted uplink transmission and uplink buffer data with respect to a period of time including the instance of time in which the device receives an uplink grant.

The AI/ML 2002 may include an LSTM network or a reinforcement learning model as exemplarily provided with respect to FIG. 8 and FIG. 9, and the AI/ML may perform similar operations as provided in respective sections. With respect to the LSTM network, the input data 2001 may include a time-series data and the AI/ML 2002 may be further configured to optimize the machine learning model parameters based on the amount of data scheduled for a transmission to the BS at least for an instance of time that the device receives information indicating an uplink grant from the BS, or for a period of time including the instance of time.

With respect to the reinforcement learning model application of the AI/ML 2002, the AI/ML 2002 may determine rewards for observation states based on based on the amount of data scheduled for a transmission to the BS at least for an instance of time that the device receives information indicating an uplink grant from the BS, or for a period of time including the instance of time. In various examples, the AI/ML may receive the information indicating the amount of data from uplink buffer data stored in the memory.

FIG. 21 exemplarily shows an illustration of an AI/ML, which the AI/ML module 1902 may implement. The AI/ML 2102 may be configured to receive the input data 2101 and provide an output 2103 indicating a predicted amount of data in uplink buffers. The AI/ML 2102 may include a trained AI/ML 2102 that is configured to predict the amount of data in uplink buffers for a UE based on the input data 2101. In this illustrative example, the input data 2101 may include the uplink buffer data. Furthermore, the input data 2101 may also include the context information as provided in accordance with this disclosure.

The output 2103 of the AI/ML 2102 may include information indicating whether there is a predicted uplink transmission for the device, or not (e.g. a binary value). The output 2103 may include information indicating the amount of data scheduled for transmitting to the BS in uplink buffers for a predicted uplink transmission to the BS. The output 2103 may include information indicating the amount of data in uplink buffers. The AI/ML 2102 may be configured to provide predictions with respect to a predefined amount of time later than the current time. The output 2103 may include information indicating a time with respect to the prediction. The output 2103 may include a BSR ready for transmission to the BS. The output 2103 may further include information indicating a confidence score for the prediction.

Based on the output 2103, the processor 1900 of the device may send a BSR indicating the predicted amount of data in uplink buffers to the BS to request uplink resources to transmit the data indicated with the BSR from the BS. The processor 1900 may further encode a message including the BSR. The processor may encode the message based on the output 2103, for example after a predefined period of time in response to an output indicating the predicted uplink transmission. The encoded message may include a MAC control element (MAC CE) indicating the amount of the data. The AI/ML 2102 may employ similar methods to perform predictions as provided with respect to FIG. 20.

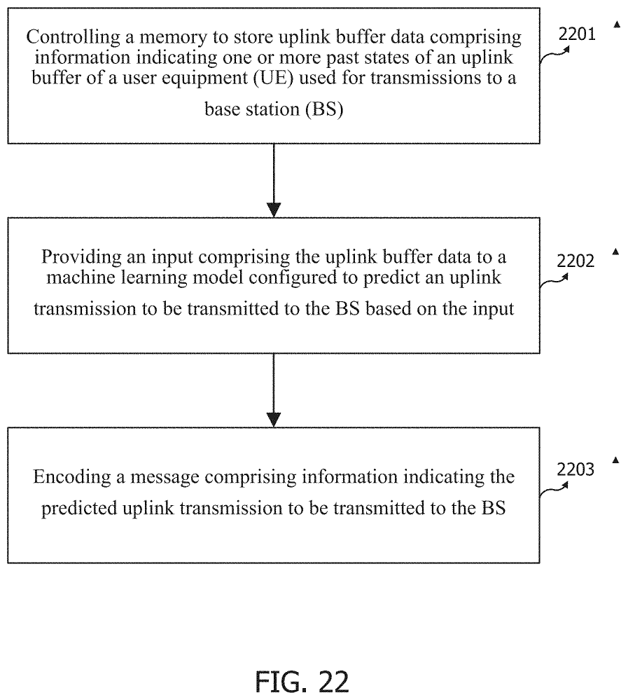

FIG. 22 shows an example of a method. The method may include controlling 2201 a memory to store uplink buffer data comprising information indicating one or more past states of an uplink buffer of a user equipment (UE) used for transmissions to a base station (BS), providing 2202 an input comprising the uplink buffer data to a machine learning model configured to predict an uplink transmission to be transmitted to the BS based on the input, encoding 2203 a message comprising information indicating the predicted uplink transmission to be transmitted to the BS. A non-transitory computer-readable medium may include instructions which, if executed by a processor, cause the processor to perform the method.

Once a BS receives an SR from a terminal device (e.g. UE), the BS may allocate an uplink channel (e.g. PUSCH) for the UE. Then, the BS may receive a BSR from the UE indicating the amount of data in the uplink buffers of the UE scheduled for a transmission. In response to received BSR, the BS may allocate necessary uplink data channel resources for the UE based on the received BSR. It may be desirable for the BS to predict when data packets may arrive from UEs or when data packets may arrive to uplink buffers of the UEs with an intention to allocate PUSCH resources beforehand and reduce the probability of an experienced latency at the UEs.

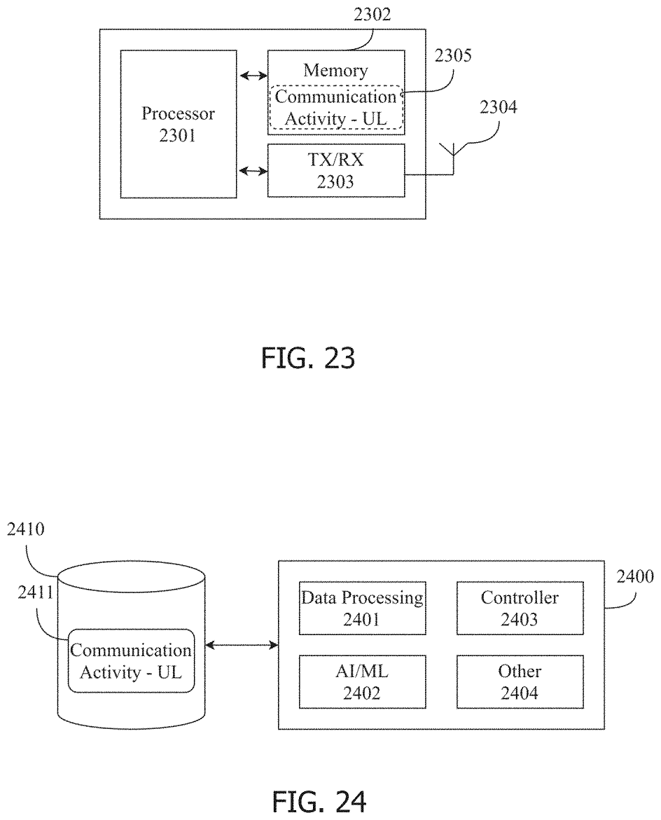

FIG. 23 shows an example of a device according to various examples in this disclosure. The device is depicted as a radio communication device in this illustrative example, comprising a processor 2301, a memory 2302, and a transceiver 2303 configured to receive and transmit radio communication signals using an antenna element 2304. In one example, a BS may include the device. The illustration depicts that there is one antenna element coupled to the transceiver 2303, however, this should not be considered as limiting, and the radio communication device may be coupled to any number of antenna elements. The transceiver 2303 may include a plurality of antenna ports couplable to a plurality of antenna elements. The processor 2301 may include one or more processors which may include a baseband processor and an application processor. The processor 2301 may be configured to perform various layer functions of a network stack to perform communication functions based on a communication reference model, such as open systems interconnection (OSI) model.

The memory 2302 may be further configured to store uplink communication activity data 2305 including information indicating uplink communication activities between the BS and one or more UEs. In various examples, the uplink communication activity data 2305 may include an amount of data received from one or more UEs. The uplink communication activity data 2305 may further include information indicating received BSRs from the one or more UEs. The uplink communication activity data 2305 may further include information indicating QoS parameters with respect to the data received from the one or more UEs. Furthermore, the uplink communication activity data may include information indicating uplink channel requests for the one or more UEs.

Furthermore, the processor 2301 may perform various functions with respect to the device including any type of functions that a BS may perform based on 3GPP standards with respect to LTE or 5G NR. Especially with respect to various aspects of this disclosure, the processor 2301 may configure uplink or downlink radio resources for each UE that the BS is communicatively coupled to. In particular, the processor 2301 may be configured to allocate and schedule time and frequency resources for each UEs in the cell in which UEs may transmit and/or receive radio communication signals, determine MCS parameters for each UE in the cell to use, perform user-selections in a multi-user environment, provide a closed-loop power control for each UE to control their transmit powers, etc.

The processor 2301 may predict an uplink transmission with respect to a UE of the one or more UEs based on the uplink communication activity data 2305 using a trained machine learning model. The processor 2301 may provide the uplink communication activity data 2305 to an input of a trained artificial intelligence/machine learning model (AI/ML). The AI/ML may be configured to provide an output including a predicted uplink communication activity of the UE.

The processor 2301 may periodically provide the input data to the AI/ML. The processor 2301 may provide the input data to the AI/ML based on a predefined event. For example, the processor 2301 may provide the input data to the AI/ML in case a determined load of the cell that the device serves is below a predefined threshold. Because the processor 2301 may use the output of the AI/ML to allocate resources for the UE, it may desirable to perform predictions with the AI/ML to allocate resources when the resources are less limited and can be employed in order to achieve higher QoS for the UE.

The processor 2301 may implement the AI/ML based on a plurality of machine model parameters stored in the memory 2302, or provide the uplink communication activity data 2305 to an external processor or an external computing device that is configured to implement the AI/ML as provided in this disclosure. The processor 2301 may include an accelerator or a neuromorphic processor to implement the AI/ML.

The processor 2301 may generate the uplink communication activity data 2305 according to operations of the device when the device is connected to the other communication devices over the radio connection. The processor 2301 may access the required information for the context information through various sources, such as RRC configuration messages exchanged between the BS and the one or more UEs, Medium Access Layer (MAC) information exchanged between the BS and the one or more UEs, etc. The processor 2301 may access the information that is stored in the memory 2302 for other operations to obtain the information with respect to the context information when it is desired and perform operations as provided in this disclosure. At least for the uplink communication activity data 2405 that the processor 2301 may generate, the processor 2301 may further store time information for a respective attribute. The time information may indicate the instance of time that the processor 2301 has generated the respective portion of the uplink communication activity data 2305, or the instance of time respective portion of the uplink communication activity data 2305 relates to. Furthermore, once the respective AI/ML provides an output, the processor 2301 may perform various actions with respect to the output of the AI/ML as provided in this disclosure.

FIG. 24 shows an example of a processor and a memory of a device according to various aspects provided in this disclosure. The processor 2400 is depicted to include various functional modules that are configured to provide various functions respectively. The skilled person would recognize that the depicted functional modules are provided to explain various operations that the processor 2400 may be configured to. Similarly, the memory 2410 is depicted to include the uplink communication activity data 2411 and the uplink communication activity data 2411 as blocks, however, the memory may store the channel quality data 2411 and the uplink communication activity data 2411 in any kind of configuration, which may further be provided in this disclosure in various examples. Furthermore, the AI/ML 2402 is depicted as it is implemented in the processor 2400 only as an example, and any type of AI/ML implementations which may include the implementation of the AI/ML in an external processor, such as an accelerator, a graphics processing unit (GPU), a neuromorphic chip, or in a cloud computing device, or in a memory (e.g. the memory 2410) may also be possible according to any methods.

The processor 2400 may include a data processing module 2401 that is configured to process data and generate at least a portion of the uplink communication activity data 2411 as provided in various examples in this disclosure. The uplink communication activity data 2411 may include information for the past operations that the device has performed in the past for at least within a period of time in a plurality of instances of time. The data processing module 2401 may generate a portion of the uplink communication activity data 2411 according to the operations of the device. The uplink communication activity data 2411 may include uplink buffer information as provided in this disclosure along with the uplink communication activity data 2411. The uplink communication activity data 2411 may include information in a time-series configuration.

The data processing module 2401 may access information directly for a portion of uplink communication activity data 2411 that is already stored in the memory 2410 for operations of other entities. For example, the memory 2410 may include already the information related to received BSRs from the one or more UEs, so the data processing module 2401 may not generate the same information to regard that particular information as the uplink communication activity data 2411. The data processing module 2401 may obtain the information to be used as the uplink communication activity data 2411 based on exchanged messages between the BS and the UE. The data processing module 2401 may obtain various information from messages received from the BS.

The uplink communication activity data 2411 may include information with respect to a plurality of attributes about the device and activities of the device. The uplink communication activity data 2411 may include information which the AI/ML 2402 may use to predict an uplink communication activity for a UE of the one or more UEs. The uplink communication activity data 2411 may include information in a time-series configuration for a plurality of instances of time.

The uplink communication activity data 2411 may include an amount of data received for the one or more UEs including the UE. The data processing module 2401 may obtain the amount of data that the device (BS) may receive from the one or more UEs based on received data in a buffer. The uplink communication activity data 2411 may further include BSRs received from the one or more UEs indicating an amount of data to be scheduled for transmission at each of the one or more UEs. In various examples, the uplink communication activity data 2411 may include BSR information that the data processing module 2401 may obtain from a received BSR. For example, the BSR information may include a logical channel identifier or a logical channel group identifier (LCG ID) and an indication of the amount of data in uplink buffers (Buffer Size) of the sender UE.

The network characteristics or expected network measures may be represented by Quality of Services (QoS) requirements with respect to the respective application, or Quality of Experience (QoE) requirements with respect to the respective application, a further quality score for the respective application, or a latency tolerance of the application. Further categories that may define the latency tolerance or other perceptual measures that the applications may provide may further be used. Such information may provide an insight with respect to the resources that the applications may need during their operation and accordingly, may affect the prediction of the communication activity.

Furthermore, the uplink communication activity data 2411 may include parameters with respect to quality of service (QoS) requirements and/or constraints for received uplink data from the one or more UEs. In various examples, the processor 2400 (e.g. other processing functions 2404) may determine the QoS parameters for received data based on assigned QoS parameters to one or more QoS flows received from the one or more UEs. The processor 2400 may determine the QoS parameters based on any information indicating a kind of priority with respect to received QoS flows. QoS parameters of the QoS flows may include a 5G QoS identifier (5QI) or an allocation and retention priority (ARP). In various examples, the processor 2400 may store QoS needs (e.g. QoS parameters based on received uplink data) for the one or more other UEs that are communicatively coupled to the BS.

Furthermore, the uplink communication activity data 2411 may include received requests of resources from the one or more UEs. Such requests of resources may also include request of uplink channels. Requests of resources may further include information indicating traffic needs of a UE. Such requests may indicate traffic needs for a UE in which the BS may take under consideration to configure radio resources for the UE. One exemplary request of resources include an SR.

Furthermore, the uplink communication activity data 2411 may include information with respect to received data at least for a period of time, or for a plurality of periods of time. The data processing module 2401 may monitor the network traffic with respect to radio communication signals that the device may receive and store information with respect to received data, such as the amount of data received at a period of time, type of received data, and such.

The data processing module 2411 may arrange the uplink communication activity data 2411 in a configuration indicating a UE of the one or more UEs with respect to the provided information. For example, the uplink communication activity data may include a UE identifier for each of the one or more UEs, and the information that the uplink communication activity data 2411 includes the UE identifier indicating the UE that a particular information element relates to. As an example, information elements in the uplink communication activity data 2411 may include a tuple, indicating the related information (e.g. a BSR information) with the UE identifier that has transmitted the BSR providing the BSR information. In various examples, the tuple may further include time information indicating the time that the device (BS) has received the BSR.

The AI/ML module 2402 may implement the AI/ML. The AI/ML module 2402 may include similar operations and functions as provided with respect to the AI/ML module 502. The AI/ML module 2402 may implement an AI/ML which the details of are provided according to the AI/ML module 502 and will not be repeated here. The controller 2403 and the other processing functions 2404 may also function in a similar manner to the processor 500.

For example, the controller 2403 may control the AI/ML module 2402 according to a predefined event as provided with respect to FIG. 5. For example, the controller 2403 may provide instructions to the AI/ML module 2402 to operate a first AI/ML configured to predict an uplink communication activity for a UE based on the input data including the uplink communication activity data 2411. Once the first AI/ML provides an output indicating that there is a predicted uplink communication activity from the UE based on the input data, the controller 2403 may provide instructions to the AI/ML module 2402 to operate a second AI/ML mode configured to predict an amount of data to be scheduled for uplink transmissions from the UE based on the input data including the uplink communication activity data 2411.

The controller 2403 may further access information indicating whether the device has already granted an uplink communication channel for the UE, and the controller 2403 may provide instructions to the AI/ML module 2402 in a similar manner to operate either the first AI/ML when there is no granted uplink communication channel for the UE, or when there is no granted uplink communication channel of a desired channel type for the UE, or the second AI/ML when there is a granted uplink communication channel for the UE, or there is a granted uplink communication channel of the desired channel type for the UE.

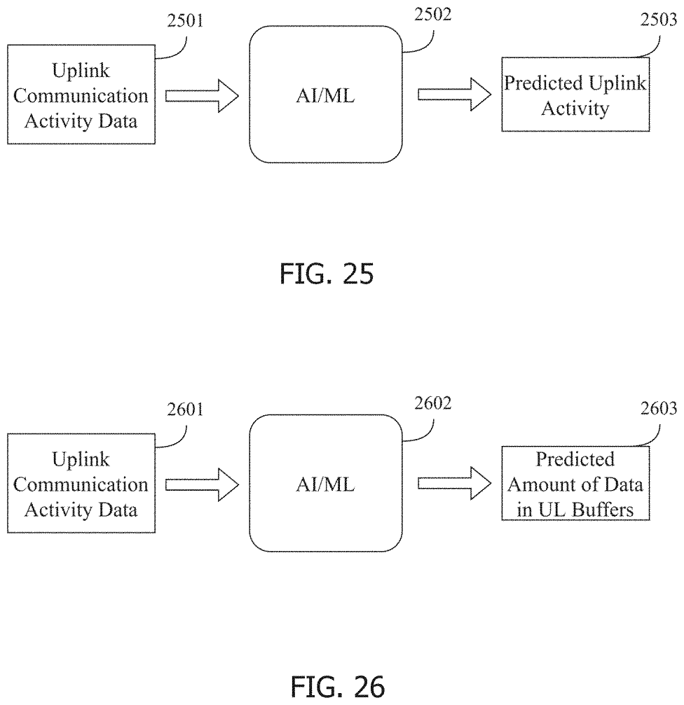

FIG. 25 shows an example of an AI/ML which the AI/ML module 2402 may implement. The AI/ML 2502 may be configured to receive the input data 2501 and provide an output 2503 indicating a predicted uplink communication activity for the UE. The AI/ML 2502 may include a trained AI/ML 2502 that is configured to predict uplink communication activities for the respective UE based on the input data 2501. In this illustrative example, the input data 2501 may include the uplink communication activity data as provided in accordance with this disclosure.

The output 2503 of the AI/ML 2502 may include information indicating whether there is a predicted uplink transmission for the UE, or not (e.g. a binary value). The output 2503 may include information indicating whether there is a predicted uplink channel request for the device from the UE at a specific instance of time. The AI/ML 2502 may be configured to provide predictions with respect to a predefined amount of time later than the current time. The output 2503 may include information indicating a time for the predicted uplink communication activity of the UE. The output 2503 may include a predicted SR from the UE. The output 2503 may further include a prediction with respect to the amount of data for the predicted uplink transmission to the device, or the amount of data in uplink buffers of the UE. The output 2503 may further include information indicating a confidence score for the prediction.

Based on the output 2503, the processor 2400 of the device may send an SR to the BS to request an uplink channel from the BS. The processor 2400 may grant an uplink channel for the UE based on an output indicating a predicted uplink channel request from the UE. The processor 2400 may encode a message indicating the grant of the uplink channel to be transmitted to the respective UE based on the predicted output. The processor 2400 may further encode a message including a BSR request based on the predicted uplink communication activity of the UE, for transmission to the UE based on the output 2503, for example after a predefined period of time in response to an output indicating the predicted uplink transmission. The processor 2400 may configure uplink radio resources for the UE based on the predicted communication activity.

The trained AI/ML 2502 may be obtained via an online and/or offline training. For the offline training, a training agent may train the AI/ML 2502 based on conditions of the device including the constraints of the device (e.g. cell capacity), BS capabilities, etc. in a past instance of time with a target to obtain the outputs as provided with respect to this example. Furthermore, the training agent may train the AI/ML 2502 (e.g. by adjusting the machine learning model parameters stored in the memory) using online training methods based on the latest (or actual) implementation conditions, such as load of the cell, etc. Furthermore, the processor may further optimize the AI/ML 2502 based on previous inference results including the predicted uplink communication activity for the UE, and possibly based on a performance metric with respect to the predicted communication activity for the UE and amount of data received from the UE in response to an action with respect to the predicted communication activity (e.g. allocation of resources, grant of an uplink channel, etc.) for a period of time including the instance of time in which the device performs the action.

The AI/ML 2502 may include an LSTM network or a reinforcement learning model as exemplarily provided with respect to FIG. 8 and FIG. 9, and the AI/ML may perform similar operations as provided in respective sections. With respect to the LSTM network, the input data 2501 may include a time-series data and the AI/ML 2502 may be further configured to optimize the machine learning model parameters based on the amount of data received from the UE in response to an action with respect to the predicted communication activity (e.g. allocation of resources, grant of an uplink channel, etc.) for a period of time including the instance of time in which the device performs the action.

With respect to the reinforcement learning model application of the AI/ML 2502, the AI/ML 2502 may determine rewards for observation states based on based on the amount of data received from the UE in response to an action with respect to the predicted communication activity (e.g. allocation of resources, grant of an uplink channel, etc.) for a period of time including the instance of time in which the device performs the action. In various examples, the AI/ML may receive the information indicating the amount of data from uplink buffer data stored in the memory.

FIG. 26 exemplarily shows an illustration of an AI/ML, which the AI/ML module 1902 may implement. The AI/ML 2602 may be configured to receive the input data 2601 and provide an output 2603 indicating a predicted amount of data to be scheduled for transmission by the UE to the device. The AI/ML 2602 may include a trained AI/ML 2602 that is configured to predict the amount of data to be scheduled for transmission by the UE to the device based on the input data 2601. In this illustrative example, the input data 2601 may include uplink communication activity data as provided in accordance with this disclosure.

The output 2603 of the AI/ML 2602 may include information indicating whether there is a predicted uplink transmission for the device, or not (e.g. a binary value). The output 2603 may include information indicating the amount of data to be scheduled for transmission by the UE to the device. The output 2603 may include information indicating the amount of data in uplink buffers of the UE. The AI/ML 2602 may be configured to provide predictions with respect to a predefined amount of time later than the current time. The output 2603 may include information indicating a time with respect to the prediction. The output 2603 may include a BSR to be received from the UE. The output 2603 may further include information indicating a confidence score for the prediction.

Based on the output 2603, the processor 2400 may configure uplink radio resources for the UE based on the predicted amount of data. The processor 2400 may allocate adequate resources based on the predicted amount of data for the UE. The processor 2400 may further encode a message indicating the configured uplink radio resources for a transmission to the UE. of the device may send a BSR indicating the predicted amount of data in uplink buffers to the BS to request uplink resources to transmit the data indicated with the BSR from the BS. The AI/ML 2602 may employ similar methods to perform predictions as provided with respect to FIG. 25.

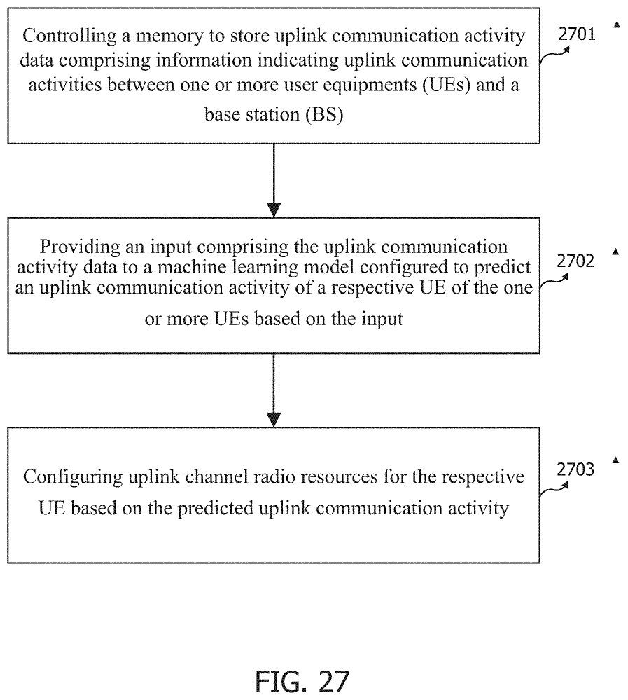

FIG. 27 shows an example of a method. The method may include controlling 2701 a memory to store uplink communication activity data comprising information indicating uplink communication activities between one or more user equipments (UEs) and a base station (BS), providing 2702 an input comprising the uplink communication activity data to a machine learning model configured to predict an uplink communication activity of a respective UE of the one or more UEs based on the input, and configuring 2703 uplink channel radio resources for the respective UE based on the predicted uplink communication activity. A non-transitory computer-readable medium may include one or more instructions which, if executed by a processor, cause the processor to perform the method.

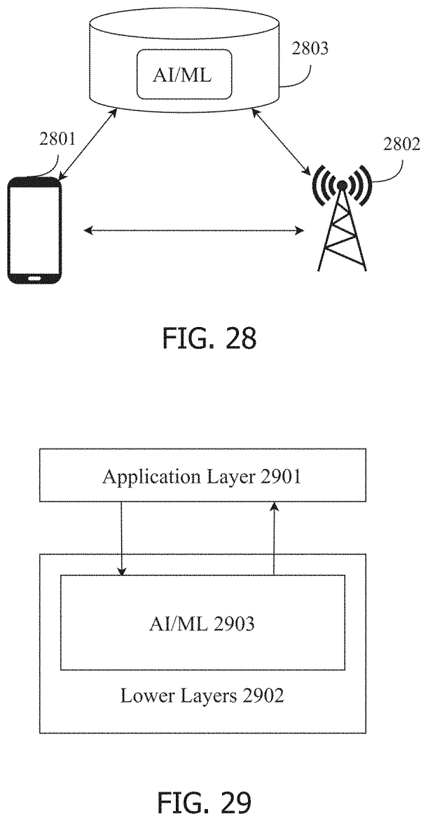

FIG. 28 exemplarily shows an illustration of a radio access network. A first device 2801 that is depicted as a UE including the device according various aspects as provided in this disclosure may communicate with a second device 2802 that is depicted as a BS including the device according to various aspects as provided in this disclosure. The first device 2801 and/or the second device 2802 are further communicatively coupled to a computing device (e.g. a cloud computing device) 2803 that implements the AI/ML as provided in this disclosure. Accordingly, the respective processors of the first device 2801 and/or the second device 2802 may provide the input to the computing device 2803 to obtain the output of the AI/ML.

FIG. 29 shows an illustration with respect to AI/ML. In accordance with various aspects of this disclosure, AI/ML modules may use input data from lower layers of the protocol stack according to communication reference model. Accordingly, in various examples that processors may implement the AI/ML module (e.g. the AI/ML module 502) as provided in this disclosure, the processors may perform application layer functions for an application layer 2901 of a communication reference model (e.g. OSI) and lower layer functions for a lower layer 2902 of the communication reference model that is lower than the application layer. In various examples, the lower layer 2902 may include MAC layer or PHY layer.

The processor may implement the AI/ML module 2903 within the lower layer functions. Accordingly, the AI/ML module 2903 may obtain various type of information, such as CQI values, BSR information, etc. using the lower layer functions as the processor perform operations with respect to CQI values and/or BSR information (or any other information that the processor may process with the lower layer functions). For various aspects, data processing modules as provided in this disclosure may also be implemented within the lower layer to operate with lower layer functions. Accordingly, the AI/ML module 2903 (or data processing modules) may obtain information related to the application layer 2901 (e.g. running applications, application information, QoS requirements of the applications, expected network traffic for one or more running applications) via cross-layer information that the application layer functions may provide.

Furthermore, the AI/ML module 2903 may provide the output to the application layer 2901 from the lower layer 2902 using the lower layer functions via cross-layer information. For example, the AI/ML module 2903 may provide the output including a predicted CQI parameter to the functions of the application layer using cross-layer information, and the processor of the device may perform application layer functions based on the predicted CQI parameter.

The output of the AI/ML module 2903 (e.g. the predicted CQI parameter) may represent a potential resulting impact with respect to the expected downlink network traffic and the application layer functions may employ the output to perform various adjustments. It may be desirable to adaptively adjust various parameters at the application layer 2901 using the application layer functions with an intention to prepare QoS impact for the running applications and to adjust and/or limit the uplink traffic for future. It is noted that there may be a correlation between the CQI value and the uplink channel conditions, especially in the case of time division duplex (TDD) operation. Furthermore, it may be desirable to anticipate expected traffic arrival rate in the downlink and anticipate the uplink traffic resources (e.g. in TDD) and perform application layer functions to adjust the traffic in the uplink.

Accordingly, based on a received output of the AI/ML module 2902 via cross-layer information, the processor may adjust the QoS parameters for running applications in the application layer, adjust uplink communication requests for the running applications, limit scheduled uplink traffic for the running applications. The received output of the AI/ML module 2902 may include the predicted CQI parameter.

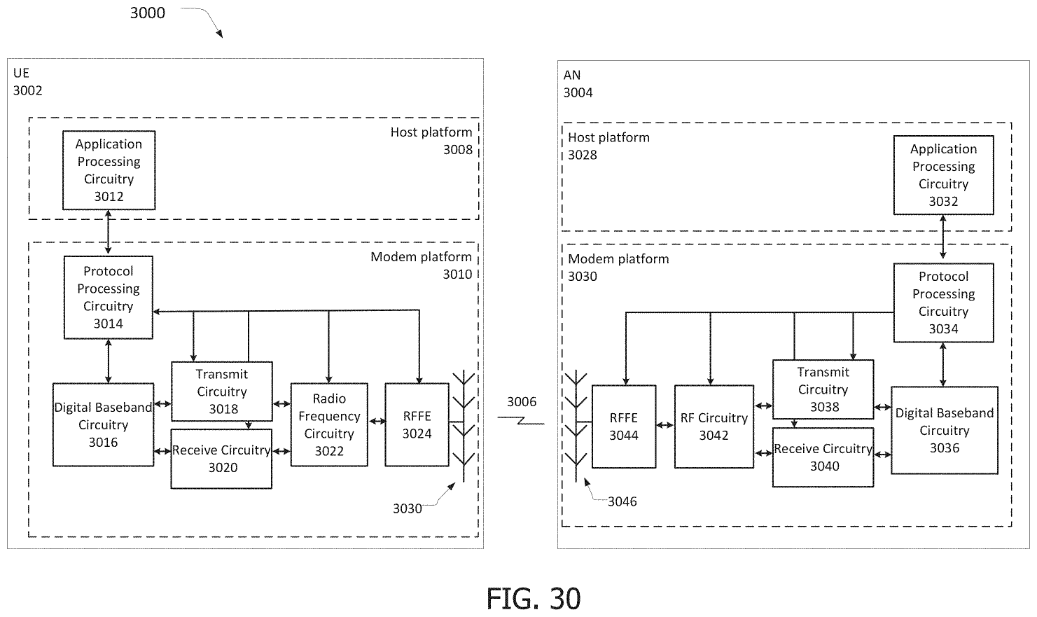

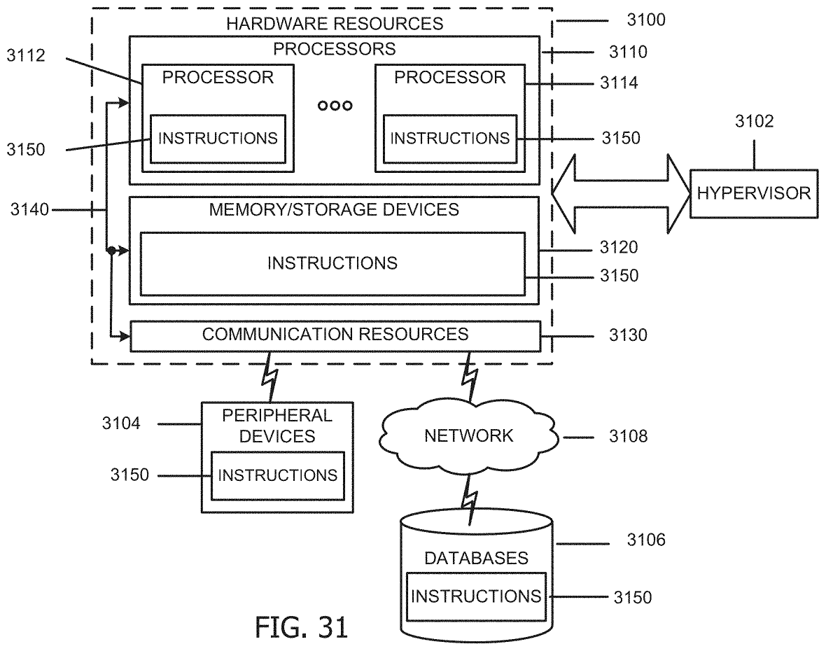

FIG. 30 illustrates a wireless network 3000 in accordance with various aspects. The wireless network 3000 may include a UE 3002 in wireless communication with an AN 3004. The UE 3002 and AN 3004 may be similar to, and substantially interchangeable with, like-named components described elsewhere herein.

The UE 3002 may be communicatively coupled with the AN 3004 via connection 3006. The connection 806 is illustrated as an air interface to enable communicative coupling, and can be consistent with cellular communications protocols such as an LTE protocol or a 5G NR protocol operating at mmWave or sub-6 GHz frequencies.

The UE 3002 may include a host platform 3008 coupled with a modem platform 3010. The host platform 3008 may include application processing circuitry 3012, which may be coupled with protocol processing circuitry 3014 of the modem platform 3010. The application processing circuitry 3012 may run various applications for the UE 3002 that source/sink application data. The application processing circuitry 3012 may further implement one or more layer operations to transmit/receive application data to/from a data network. These layer operations may include transport (for example user datagram protocol (UDP)) and Internet (for example, internet protocol (IP)) operations

The protocol processing circuitry 3014 may implement one or more of layer operations to facilitate transmission or reception of data over the connection 3006. The layer operations implemented by the protocol processing circuitry 3014 may include, for example, MAC, RLC, PDCP, RRC and NAS operations.

The modem platform 3010 may further include digital baseband circuitry 3016 that may implement one or more layer operations that are “below” layer operations performed by the protocol processing circuitry 3014 in a network protocol stack. These operations may include, for example, physical layer (PHY) operations including one or more of hybrid automatic repeat request (HARQ)-acknowledgment (ACK) functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 3010 may further include transmit circuitry 3018, receive circuitry 3020, RF circuitry 3022, and RF front end (RFFE) 3024, which may include or connect to one or more antenna panels 3026. Briefly, the transmit circuitry 3018 may include a digital-to-analog converter, mixer, intermediate frequency (IF) components, etc.; the receive circuitry 3020 may include an analog-to-digital converter, mixer, IF components, etc.; the RF circuitry 3022 may include a low-noise amplifier, a power amplifier, power tracking components, etc.; RFFE 3024 may include filters (for example, surface/bulk acoustic wave filters), switches, antenna tuners, beamforming components (for example, phase-array antenna components), etc. The selection and arrangement of the components of the transmit circuitry 3018, receive circuitry 3020, RF circuitry 3022, RFFE 3024, and antenna panels 3026 (referred generically as “transmit/receive components”) may be specific to details of a specific implementation such as, for example, whether communication is time division multiplexing (TDM) or frequency division multiplex (FDM), in mmWave or sub-6 gHz frequencies, etc. In some aspects, the transmit/receive components may be arranged in multiple parallel transmit/receive chains, may be disposed in the same or different chips/modules, etc.

In some aspects, the protocol processing circuitry 3014 may include one or more instances of control circuitry (not shown) to provide control functions for the transmit/receive components.

A UE reception may be established by and via the antenna panels 3026, RFFE 3024, RF circuitry 3022, receive circuitry 3020, digital baseband circuitry 3016, and protocol processing circuitry 3014. In some aspects, the antenna panels 3026 may receive a transmission from the AN 3004 by receive-beamforming signals received by a plurality of antennas/antenna elements of the one or more antenna panels 3026.

A UE transmission may be established by and via the protocol processing circuitry 3014, digital baseband circuitry 3016, transmit circuitry 3018, RF circuitry 3022, RFFE 3024, and antenna panels 3026. In some aspects, the transmit components of the UE 3004 may apply a spatial filter to the data to be transmitted to form a transmit beam emitted by the antenna elements of the antenna panels 3026.

Similar to the UE 3002, the AN 3004 may include a host platform 3028 coupled with a modem platform 3030. The host platform 3028 may include application processing circuitry 3032 coupled with protocol processing circuitry 3034 of the modem platform 3030. The modem platform may further include digital baseband circuitry 3036, transmit circuitry 3038, receive circuitry 3040, RF circuitry 3042, RFFE circuitry 3044, and antenna panels 3046. The components of the AN 3004 may be similar to and substantially interchangeable with like-named components of the UE 3002. In addition to performing data transmission/reception as described above, the components of the AN 3008 may perform various logical functions that include, for example, radio network controller (RNC) functions such as radio bearer management, uplink and downlink dynamic radio resource management, and data packet scheduling.

FIG. 31 is a block diagram illustrating components, according to some example aspects, able to read instructions from a machine-readable or computer-readable medium (e.g., a non-transitory machine-readable storage medium) and perform any one or more of the methodologies discussed herein. Specifically, FIG. 31 shows a diagrammatic representation of hardware resources 3100 including one or more processors (or processor cores) 3110, one or more memory/storage devices 3120, and one or more communication resources 3130, each of which may be communicatively coupled via a bus 3140 or other interface circuitry. For aspects where node virtualization (e.g., NFV) is utilized, a hypervisor 3102 may be executed to provide an execution environment for one or more network slices/sub-slices to utilize the hardware resources 3100.

The processors 3110 may include, for example, a processor 3112 and a processor 3114. The processors 3110 may be, for example, a central processing unit (CPU), a reduced instruction set computing (RISC) processor, a complex instruction set computing (CISC) processor, a graphics processing unit (GPU), a digital signal processer (DSP) such as a baseband processor, an application-specific integrated circuit (ASIC), an field-programmable gate array (FPGA), a radio-frequency integrated circuit (RFIC), another processor (including those discussed herein), or any suitable combination thereof.

The memory/storage devices 3120 may include main memory, disk storage, or any suitable combination thereof. The memory/storage devices 3120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 3130 may include interconnection or network interface controllers, components, or other suitable devices to communicate with one or more peripheral devices 3104 or one or more databases 3106 or other network elements via a network 3108. For example, the communication resources 3130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 3150 may include software, a program, an application, an applet, an app, or other executable code for causing at least any of the processors 3110 to perform any one or more of the methodologies discussed herein. The instructions 3150 may reside, completely or partially, within at least one of the processors 3110 (e.g., within the processor's cache memory), the memory/storage devices 3120, or any suitable combination thereof. Furthermore, any portion of the instructions 3150 may be transferred to the hardware resources 3100 from any combination of the peripheral devices 3104 or the databases 3106. Accordingly, the memory of processors 3110, the memory/storage devices 3120, the peripheral devices 3104, and the databases 3106 are examples of computer-readable and machine-readable media. In various examples, a non-transitory computer-readable medium including one or more instructions which, if executed by a processor, cause the processor to: access environment information including an indication of an amount of a crowd of road users intersecting with a predetermined route of a vehicle in a road environment, prioritize an anticipated movement of at least one road user of the crowd of road users relative to a predicted movement of the vehicle within the predetermined route based on the amount of the crowd of road users; and determine an action to be taken by the vehicle allowing the anticipated movement of the at least one road user of the crowd of road users. The one or more instructions may further cause the processor to act as provided in this disclosure.

The following examples pertain to further aspects of this disclosure.

In example 1, A device may include: a memory configured to store channel quality data may include information indicating a quality of a communication channel between a base station (BS) and a user equipment (UE); a processor configured to: provide an input may include the channel quality data to a machine learning model configured to predict a channel quality indicator (CQI) based on the input; encode a channel quality information based on the predicted CQI for a transmission to the BS.

In example 2, the subject matter of example 1, can optionally include that the channel quality data includes a plurality of measurement results performed on received radio communication signals via the communication channel; can optionally include that each measurement result is configured to represent an estimated quality of the communication channel for an instance of time. In example 3, the subject matter of example 2, can optionally include that the plurality of measurement results includes one of a plurality of in-phase and quadrature samples based on the received radio communication signals, a plurality of Fast Fourier Transform (FFT) samples based on the received radio communication signals, signal measurements may include at least one of a reference signal received power (RSRP), a received signal strength indicator (RSSI), or reference signal received quality (RSRQ).

In example 4, the subject matter of example 3, can optionally include that the channel quality data includes a plurality of values indicating the channel quality at a plurality of instance of time; can optionally include that each value is obtained by mapping a measurement result to a predefined channel quality mapping table. In example 5, the subject matter of any one of examples 1 to 4, can optionally include that the channel quality data includes a plurality of channel quality indicators for the plurality of instances of time. In example 6, the subject matter of any one of examples 1 to 5, can optionally include that the memory is further configured to store context information may include information indicating at least one of a mobility of the UE, a location of the UE, a velocity of the UE, or a moving direction of the UE relative to the BS. In example 7, the subject matter of example 6, can optionally include that the input of the machine learning model includes the context information. In example 8, the subject matter of any one of examples 6 or 7, can optionally include that the context information further includes information indicating at least one of a time, a velocity of the UE, an identifier for a network operator operating through the BS, an identifier of the BS, a network mode, a measured downlink or uplink rate for a period of time, a modulation level, a past power level, a number of resource blocks allocated for the UE, a number of retransmissions to transmit communication signals to the BS.

In example 9, the subject matter of any one of examples 6 to 8, can optionally include that the processor is further configured to decode a received message to obtain at least a portion of the context information from the BS. In example 10, the subject matter of any one of examples 6 to 9, can optionally include that the context information further includes an indication for at least one of a first instance of time of a generation of at least one previous CQI, a second instance of time of a transmission of information may include an indication of the at least one previous CQI, or a third instance of time of a downlink communication scheduled in response to the at least one previous CQI, or a predetermined time gap information representing a period of time between a generation of the channel quality information and a reception of the generated channel quality information by the BS. In example 11, the subject matter of example 10, can optionally include that the processor is configured to determine the time gap information based on at least one of the first instance of time, the second instance of time, or the third instance of time using a second machine learning model.

In example 12, the subject matter of example 11, can optionally include that the machine learning model is configured to predict the CQI for an instance of time after a period of time may include the period of time indicated by the determined time gap information. In example 13, the subject matter of any one of examples 1 to 12, can optionally include that the machine learning model is configured to provide the output may include an indication of resource blocks for a CQI measurement. In example 14, the subject matter of example 13, may further include: a measurement circuit to perform CQI measurements on a plurality of resource blocks; can optionally include that the processor is configured to determine resource blocks to be measured based on the indication of resource blocks for the CQI measurement. In example 15, the subject matter of any one of examples 1 to 14, can optionally include that the processor is configured to control the measurement circuit to perform a first CQI measurement at a first instance of time; can optionally include that the processor is configured to control the measurement circuit to perform a second CQI measurement at a second instance of time; can optionally include that the processor is configured to control the machine learning model to predict the CQI at a third instance of time that is between the first instance of time and the second instance of time. In example 16, the subject matter of any one of examples 1 to 15, can optionally include that the processor is configured to decode information indicating a radio configuration received from the BS in response to a transmitted channel quality information indicating the predicted CQI; can optionally include that the processor is configured to configure radio settings according to the decoded radio configuration.

In example 17, the subject matter of any one of examples 1 to 16, can optionally include that the memory includes a plurality of machine learning model parameters; can optionally include that the machine learning model is configured to provide the output based on the machine learning model parameters; can optionally include that the processor is further configured to adjust the machine learning model parameters based on the determined CQI and a number of retransmissions with the configured radio settings or a received hybrid automatic repeat request (HARM) feedback. In example 18, the subject matter of any one of examples 1 to 17, can optionally include that the machine learning model includes a recursive neural network long short-term memory (LSTM); can optionally include that the processor is configured to provide the input in a time-series data configuration to the LSTM. In example 19, the subject matter of example 18, can optionally include that the LSTM is configured to provide the output based on input data elements of a time window may include a plurality of consecutive instances of time.

In example 20, the subject matter of any one of examples 1 to 17, can optionally include that the machine learning model includes a reinforcement learning model; can optionally include that the processor is further configured to determine a first output parameter based on a first state indicated by the input at a first instance of time; can optionally include that the processor is further configured to determine a reward based on an observation state in which the processor reconfigure radio parameters based on a received radio configuration in response to the first output parameter; can optionally include that the processor is further configured to determine a second output parameter based on the determined reward and a second state indicated by the input at a second instance of time. In example 21, the subject matter of example 20, can optionally include that the processor is configured to determine the reward based on a number of transmissions during the observation state or a number of detected cyclic redundancy check failures during the observation state. In example 22, the subject matter of example 20 or example 21, can optionally include that the reinforcement learning model includes a multi-armed bandit reinforcement learning model; can optionally include that the objective function includes the throughput of the communication performed on the communication channel; can optionally include that the processor is configured to determine the reward based on at least one of error rates, number of retransmissions, cyclic redundancy check failures, received HARQ feedback, or buffer lengths.

In example 23, the subject matter of any one of examples 1 to 22, can optionally include that the processor is configured to perform application layer functions for an application layer of a communication reference model, and lower layer functions for a lower layer of the communication reference model that is lower than the application layer. In example 24, the subject matter of example 23, can optionally include that the machine learning model is configured to operate at the lower layer. In example 25, the subject matter of example 24, can optionally include that the processor is configured to provide the predicted CQI via a cross-layer information from the lower layer to the application layer using the lower layer functions; can optionally include that the processor is configured to perform the application layer functions based on the predicted CQI. In example 26, the subject matter of example 25, can optionally include that the processor is configured to adjust quality of service (QoS) parameters for applications running in the application layer based on the predicted CQI. In example 27, the subject matter of example 26, can optionally include that the processor is configured to adjust uplink communication requests of for the applications running in the application layer based on the predicted CQI.

In example 28, the subject matter of example 26 or 27, can optionally include that the processor is configured to limit scheduled uplink traffic for the applications running in the application layer based on the predicted CQI. In example 29, the subject matter of any one of examples 23 to 28, can optionally include that the communication reference model is an open system communication interconnection (OSI) model and the lower layer includes a medium access control (MAC) layer. In example 30, A system may include: a user equipment (UE) may include the device of any one of examples 1 to 29; an external processor that is external to the UE and configured to implement the machine learning model; can optionally include that the external processor is communicatively coupled to the UE.

In example 31, a method may include: controlling a memory to store channel quality data may include information indicating a quality of a communication channel between a base station (BS) and a user equipment (UE); providing an input may include the channel quality data to a machine learning model configured to predict a channel quality indicator (CQI) based on the input; encoding a channel quality information based on the predicted CQI for a transmission to the BS.

In example 32, a non-transitory computer-readable medium may include one or more instructions which, if executed by a processor, cause the processor to: control a memory to store channel quality data may include information indicating a quality of a communication channel between a base station (BS) and a user equipment (UE); provide an input may include the channel quality data to a machine learning model configured to predict a channel quality indicator (CQI) based on the input; encode a channel quality information based on the predicted CQI for a transmission to the BS.

In example 33, a device may include: a memory configured to store channel quality data may include information indicating a quality of a communication channel between a base station (BS) and a user equipment (UE); a processor configured to: provide an input may include the channel quality data to a machine learning model configured to determine a resource management parameter to manage radio resources for the UE based on the input; configure uplink radio resources for the UE based on the determined resource management parameter.

In example 34, the subject matter of example 33, can optionally include that the channel quality data includes a plurality of measurement results performed on received uplink communication signals via the communication channel; can optionally include that each measurement result is configured to represent an estimated quality of the communication channel for an instance of time. In example 35, the subject matter of example 34, can optionally include that the plurality of measurement results includes one of a plurality of in-phase and quadrature samples based on the received uplink communication signals, a plurality of Fast Fourier Transform (FFT) samples based on the received uplink communication signals, signal measurements may include at least one of a reference signal received power (RSRP), a received signal strength indicator (RSSI), or reference signal received quality (RSRQ). In example 36, the subject matter of any one of examples 35, can optionally include that the channel quality data includes a plurality of channel quality indicators received from the UE for the plurality of instances of time.

In example 37, the subject matter of any one of examples 33 to 36, can optionally include that the memory is further configured to store context information may include information indicating at least one of requests of resources of the UE, quality of service (QoS) parameters with respect to received data from the UE, resource requests and/or QoS parameters with respect to other UEs, detected interference on the communication channel, cell loading of the BS, frequency separation between uplink and downlink; can optionally include that the input of the machine learning model includes the context information. In example 38, the subject matter of any one of examples 37, can optionally include that the processor is configured to determine the QoS parameters based on QoS parameters of a respective QoS flow; can optionally include that the QoS parameters optionally include a 5G QoS identifier (5QI) or an allocation and retention priority (ARP). In example 39, the subject matter of any one of examples 33 to 38, can optionally include that the processor is configured to determine the input of the machine learning model based on a mode of the radio communication network that the BS operates; can optionally include that the mode is one of a frequency division duplex mode or a time division duplex mode.

In example 40, the subject matter of any one of examples 33 to 39, can optionally include that the determined resource management parameter includes a channel quality indicator (CQI) feedback cycle parameter; can optionally include that the processor is configured to reconfigure the network based on the CQI feedback cycle parameter. In example 41, the subject matter of example 40, can optionally include that the processor is configured to encode a message may include information indicating the CQI feedback cycle parameter to be transmitted to the UE; can optionally include that the processor is configured to schedule the resources for the UE based on a received CQI value in response to the indicated CQI feedback cycle parameter. In example 42, the subject matter of any one of examples 33 to 39, can optionally include that the determined resource management parameter includes a predicted CQI value for the communication channel; can optionally include that the processor is configured to configure the radio resources for the UE based on the predicted CQI value.

In example 43, the subject matter of example 42, can optionally include that the processor is configured to: configure the radio resources for the UE based on a first CQI value received from the UE at a first instance of time; configure the radio resources for the UE based on a second CQI value received from the UE at a second instance of time; configure the radio resources for the UE based on the predicted CQI value at a third instance of time between the first instance of time and the second instance of time; can optionally include that the management of the resources include allocating resources for the UE including time and frequency resources may include scheduling, user selection, MCS selection. In example 44, the subject matter of example 43, can optionally include that amount of the period of time between the first instance of time and the second instance of time is T; can optionally include that the third instance of time is configured to be after than the first instance of time of a period of time of any one of T/4, T/2, or 3T/4.

In example 45, the subject matter of any one of examples 33 to 36, may further include: a measurement circuit to perform uplink measurements on the received uplink communication signals. In example 46, the subject matter of any one of examples 33 to 45, can optionally include that the processor is further configured to encode a message may include information indicating the configured radio resources to be transmitted to the UE. In example 47, the subject matter of any one of examples 33 to 46, can optionally include that the memory includes a plurality of machine learning model parameters; can optionally include that the machine learning model is configured to provide the output based on the machine learning model parameters; can optionally include that the processor is further configured to adjust the machine learning model parameters based on the determined parameter and a number of retransmissions with a configured radio settings based on the determined resource management parameter. In example 48, the subject matter of any one of examples 33 to 47, can optionally include that the processor is further configured to implement the machine learning model based on the machine learning model parameters.

In example 49, the subject matter of any one of examples 33 to 48, can optionally include that the machine learning model includes a recursive neural network long short-term memory (LSTM); can optionally include that the processor is configured to provide the input in a time-series data configuration to an input of the LSTM. In example 50, the subject matter of example 49, can optionally include that the LSTM is configured to provide the output based on input features of a time window may include a plurality of consecutive instances of time. In example 51, the subject matter of any one of examples 33 to 48, can optionally include that the machine learning model includes a reinforcement learning model; can optionally include that the processor is further configured to determine a first output parameter based on a first state indicated by the input at a first instance of time; can optionally include that the processor is further configured to determine a reward for an observation state in which the UE communicates according the configured radio resources according to the first output parameter; can optionally include that the processor is further configured to determine a second output parameter in response to the determined reward and a second state indicated by the input at a second instance of time.

In example 52, the subject matter of example 51, can optionally include that the processor is configured to determine the reward for the observation state based on at least an error rate, a number of retransmissions performed by the UE, cyclic redundancy check failures with respect to the received uplink data, or a received buffer status report from the UE. In example 53, the subject matter of example 51 or 52, can optionally include that the reinforcement learning model includes a multi-armed bandit reinforcement learning model; can optionally include that the objective function includes the throughput of the communication performed on the communication channel; can optionally include that the processor is configured to determine the reward based on at least one of error rates, number of retransmissions, cyclic redundancy check failures, or buffer lengths. In example 54, A system may include: a base station (BS) may include the device of any one of examples 33 to 53; an external processor that is external to the BS and configured to implement the machine learning model; can optionally include that the external processor is communicatively coupled to the BS.

In example 55, a method may include: controlling a memory to store channel quality data may include information indicating a quality of a communication channel between a base station (BS) and a user equipment (UE); providing an input may include the channel quality data to a machine learning model configured to determine a resource management parameter to configure radio resources for the UE; configuring uplink radio resources for the UE based on the determined resource management parameter.

In example 56, a non-transitory computer-readable medium may include one or more instructions which, if executed by a processor, cause the processor to: control a memory to store channel quality data may include information indicating a quality of a communication channel between a base station (BS) and a user equipment (UE); provide an input may include the channel quality data to a machine learning model configured to determine a resource management parameter to configure radio resources for the UE; configure uplink radio resources for the UE based on the determined resource allocation parameter.

In example 57, a device may include: a memory configured to store uplink buffer data may include information indicating one or more past states of an uplink buffer of a user equipment (UE) used for transmissions to a base station (BS); a processor configured to: provide an input may include the uplink buffer data to a machine learning model configured to predict an uplink transmission to be transmitted to the BS based on the input; encode a message may include information indicating the predicted uplink transmission to be transmitted to the BS.

In example 58, the subject matter of example 57, can optionally include that the uplink buffer data includes information indicating an amount of data scheduled for transmission to the BS. In example 59, the subject matter of example 57 or 58, can optionally include that the uplink buffer data includes information indicating an amount of data that the uplink buffer received in a period of time for a plurality of periods of time. In example 60, the subject matter of any one of examples 57 to 59, can optionally include that the uplink buffer data includes information indicating an arrival time for the data arriving to the uplink buffer. In example 61, the subject matter of any one of examples 57 to 60, can optionally include that the memory is configured to store context information; can optionally include that the context information includes at least one of running applications, types of the running applications, quality of service (QoS) requirements of the running applications, an amount of received downlink data at a period of time for a plurality of periods of time, predicted network traffic received from an application layer for the running applications.

In example 62, the subject matter of example 61, can optionally include that the input of the machine learning model further includes the context information. In example 63, the subject matter of any one of examples 61 or 62, can optionally include that the uplink buffer is configured to operate at a radio link control (RLC) layer as an RLC entity. In example 64, the subject matter of any one of examples 61 to 63, can optionally include that the processor is configured to obtain at least a portion of the context information from an application layer entity via a cross layer information. In example 65, the subject matter of example 64, can optionally include that the processor is configured to obtain at least the predicted network traffic and the QoS requirements of the running applications from the application layer entity via a cross layer information.

In example 66, the subject matter of any one of examples 57 to 65, can optionally include that the processor is configured to determine the QoS requirements based on QoS parameters of a respective QoS flow; can optionally include that the QoS parameters optionally include a 5G QoS identifier (5QI) or an allocation and retention priority (ARP). In example 67, the subject matter of any one of examples 57 to 66, can optionally include that the processor is configured to monitor the uplink buffer to obtain the uplink buffer data. In example 68, the subject matter of any one of examples 57 to 67, can optionally include that the processor is configured to encode the message may include a scheduling request to request an uplink channel based on the predicted uplink transmission. In example 69, the subject matter of any one of examples 57 to 68, can optionally include that the processor is configured to generate a buffer status report based on an amount of data scheduled for uplink transmission in the uplink buffer in response to a received request of the buffer status report. In example 70, the subject matter of example 69, can optionally include that the encoded message includes a medium access layer control element (MAC CE) indicating the amount of data that is scheduled for the uplink transmission.

In example 71, the subject matter of any one of examples 57 to 70, can optionally include that the machine learning model is configured to predict an amount of data to be scheduled for uplink transmission. In example 72, the subject matter of example 71, can optionally include that the processor is configured to encode the message may include a buffer status report; can optionally include that the buffer status report includes information indicating the predicted amount of data to be scheduled for the uplink transmission. In example 73, the subject matter of example 72, can optionally include that the encoded message includes a medium access layer control element (MAC CE) indicating the predicted amount of data to be scheduled for the uplink transmission. In example 74, the subject matter of any one of examples 57 to 73, can optionally include that the memory includes a plurality of machine learning model parameters; can optionally include that the machine learning model is configured to provide the output based on the machine learning model parameters; can optionally include that the processor is further configured to adjust the machine learning model parameters based on the output of the machine learning model and the amount of data scheduled for the uplink transmission. In example 75, the subject matter of example 74, can optionally include that the processor is configured to adjust the machine learning model parameters based on the amount of data scheduled for the uplink transmission after a period of time in response to a grant of an uplink transmission.

In example 76, the subject matter of example 74, can optionally include that the processor is configured to adjust the machine learning model parameters based on the amount of data scheduled for the uplink transmission and the predicted amount of data to be scheduled for the uplink transmission. In example 77, the subject matter of any one of examples 74 to 76, can optionally include that the processor is further configured to implement the machine learning model based on the machine learning model parameters. In example 78, the subject matter of any one of examples 57 to 77, can optionally include that the machine learning model includes a recursive neural network long short-term memory (LSTM); can optionally include that the processor is configured to provide the input in a time-series data configuration to the LSTM. In example 79, the subject matter of example 78, can optionally include that the LSTM is configured to provide the output based on input features of a time window may include a plurality of consecutive instances of time.

In example 80, the subject matter of any one of examples 57 to 77, can optionally include that the machine learning model includes a reinforcement learning model; can optionally include that the processor is further configured to determine a first output parameter based on a first state indicated by the input at a first instance of time; can optionally include that the processor is further configured to determine a reward for an observation state in which the UE communicates according to the configured radio resources according to the first output parameter; can optionally include that the processor is further configured to determine a second output parameter based on the determined reward and a second state indicated by the input at a second instance of time. In example 81, the subject matter of example 80, can optionally include that the processor is configured to determine the reward for the observation state based on the amount of data scheduled for the uplink transmission. In example 82, the subject matter of example 80 or example 81, can optionally include that the reinforcement learning model includes a multi-armed bandit reinforcement learning model.

In example 83, a method may include: controlling a memory to store uplink buffer data may include information indicating one or more past states of an uplink buffer of a user equipment (UE) used for transmissions to a base station (BS); providing an input may include the uplink buffer data to a machine learning model configured to predict an uplink transmission to be transmitted to the BS based on the input; encoding a message may include information indicating the predicted uplink transmission to be transmitted to the BS.

In example 84, a non-transitory computer-readable medium may include one or more instructions which, if executed by a processor, cause the processor to: control a memory to store uplink buffer data may include information indicating one or more past states of an uplink buffer of a user equipment (UE) used for transmissions to a base station (BS); provide an input may include the uplink buffer data to a machine learning model configured to predict an uplink transmission to be transmitted to the BS based on the input; encode a message may include information indicating the predicted uplink transmission to be transmitted to the BS.

In example 85, a device may include: a memory configured to store uplink communication activity data may include information indicating uplink communication activities between one or more user equipments (UEs) and a base station (BS); a processor configured to: provide an input may include the uplink communication activity data to a machine learning model configured to predict an uplink communication activity of a respective UE of the one or more UEs based on the input; configure uplink channel radio resources for the respective UE based on the predicted uplink communication activity.

In example 86, the subject matter of example 85, can optionally include that the uplink communication activity data includes information indicating an amount of data received from the respective UE. In example 87, the subject matter of example 85 or example 86, can optionally include that the uplink communication activity data includes information indicating received buffer status reports received from the respective UE. In example 88, the subject matter of any one of examples 85 to 87, can optionally include that the uplink communication activity data includes information indicating quality of services (QoS) parameters with respect to the data received from the respective UE. In example 89, the subject matter of any one of examples 85 to 88, can optionally include that the uplink communication activity data includes information indicating one or more received uplink channel requests from the one or more UEs. In example 90, the subject matter of any one of examples 85 to 89, can optionally include that the uplink communication activity data includes information indicating an amount of data received from the one or more UEs. In example 91, the subject matter of any one of examples 85 to 90, can optionally include that the uplink communication activity data includes information indicating buffer status reports received from the one or more UEs.

In example 92, the subject matter of any one of examples 85 to 91, can optionally include that the uplink communication activity data includes information indicating quality of services (QoS) parameters with respect to the data received from the one or more UEs. In example 93, the subject matter of any one of examples 85 to 93, can optionally include that the uplink communication activity data includes information indicating one or more received uplink channel requests from the one or more UEs. In example 94, the subject matter of any one of examples 88 to 93, can optionally include that the QoS parameters include at least one of a 5G QoS identifier (5QI) or an allocation and retention priority (ARP). In example 95, the subject matter of any one of examples 85 to 94, can optionally include that the processor is configured to grant an uplink channel for the respective UE based on the predicted communication activity. In example 96, the subject matter of example 95, can optionally include that the processor is configured to encode a message indicating the grant of the uplink channel to be transmitted to the respective UE. In example 97, the subject matter of any one of examples 85 to 96, can optionally include that the processor is configured to request a buffer status report from the respective UE based on the predicted communication activity.

In example 98, the subject matter of any one of examples 85 to 97, can optionally include that the processor is configured to configure the uplink radio resources for the respective UE based on the predicted communication activity. In example 99, the subject matter of any one of examples 85 to 98, can optionally include that the predicted communication activity includes a predicted amount of data to be scheduled for transmission by the respective UE. In example 100, the subject matter of example 85 to 99, can optionally include that the predicted communication activity includes a predicted buffer status report. In example 101, the subject matter of any one of examples 85 to 100, can optionally include that the processor is configured to encode a message indicating configured uplink radio resources to be transmitted to the respective UE. In example 102, the subject matter of any one of examples 85 to 101, can optionally include that the processor is further configured to configure the uplink radio resources based on a current loading on the BS.

In example 103, the subject matter of any one of examples 85 to 103, can optionally include that the machine learning model is configured to provide a predicted communication activity of the one or more UEs. In example 104, the subject matter of example 103, can optionally include that the processor is further configured to configure the uplink radio resources for the respective UE based on the predicted communication activity of the one or more UEs. In example 105, the subject matter of any one of examples 85 to 104, can optionally include that the memory includes a plurality of machine learning model parameters; can optionally include that the machine learning model is configured to provide the output based on the machine learning model parameters; can optionally include that the processor is further configured to adjust the machine learning model parameters based on the predicted communication activity and the amount of data received from the respective UE in response to the predicted communication activity. In example 106, the subject matter of example 105, can optionally include that the processor is further configured to implement the machine learning model based on the machine learning model parameters.

In example 107, the subject matter of any one of examples 85 to 106, can optionally include that the machine learning model includes a recursive neural network long short-term memory (LSTM); can optionally include that the processor is configured to provide the input in a time-series data configuration to the LSTM. In example 108, the subject matter of example 107, can optionally include that the LSTM is configured to provide the output based on input features of a time window may include a plurality of consecutive instances of time. In example 109, the subject matter of any one of examples 85 to 106, can optionally include that the machine learning model includes a reinforcement learning model; can optionally include that the processor is further configured to determine a first output parameter based on a first state indicated by the input at a first instance of time; can optionally include that the processor is further configured to determine a reward for an observation state in which the BS communicates with the respective UE based on the configured radio resources according to the first output parameter; can optionally include that the processor is further configured to determine a second output parameter based on the determined reward and a second state indicated by the input at a second instance of time. In example 110, the subject matter of example 109, can optionally include that the processor is configured to determine the reward for the observation state based on the amount of data received with the configured radio resources. In example 111, the subject matter of example 110, can optionally include that the reinforcement learning model includes a multi-armed bandit reinforcement learning model.

In example 112, a system may include: a base station (BS) may include the device of any one of examples 85 to 111; an external processor that is external to the BS and configured to implement the machine learning model; can optionally include that the external processor is communicatively coupled to the BS.

In example 113, a method may include: controlling a memory to store uplink communication activity data may include information indicating uplink communication activities between one or more user equipments (UEs) and a base station (BS); providing an input may include the uplink communication activity data to a machine learning model configured to predict an uplink communication activity of a respective UE of the one or more UEs based on the input; configuring uplink channel radio resources for the respective UE based on the predicted uplink communication activity.

In example 114, a non-transitory computer-readable medium may include one or more instructions which, if executed by a processor, cause the processor to: control a memory to store uplink communication activity data may include information indicating uplink communication activities between one or more user equipments (UEs) and a base station (BS); provide an input may include the uplink communication activity data to a machine learning model configured to predict an uplink communication activity of a respective UE of the one or more UEs based on the input; configure uplink channel radio resources for the respective UE based on the predicted uplink communication activity.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal that is “indicative of” or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor or 9. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more.”

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D Points, among others, or any combination thereof. Registers, shift registers, processor registers, data buffers, among others, are also embraced herein by the term memory. The term “software” refers to any type of executable instruction, including firmware.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

The term “antenna”, as used herein, may include any suitable configuration, structure and/or arrangement of one or more antenna elements, components, units, assemblies and/or arrays. The antenna may implement transmit and receive functionalities using separate transmit and receive antenna elements. The antenna may implement transmit and receive functionalities using common and/or integrated transmit/receive elements. The antenna may include, for example, a phased array antenna, a single element antenna, a set of switched beam antennas, and/or the like.

It will be understood that when an element is referred to as being “connected” or “coupled” to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), Time-Division Multiplexing (TDM), Time-Division Multiple Access (TDMA), Multi-User MIMO (MU-MIMO), General Packet Radio Service (GPRS), extended GPRS (EGPRS), Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth (BT), Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other aspects may be used in various other devices, systems and/or networks.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN, and the like.

Some aspects may be used in conjunction with a wireless communication network communicating over a frequency band of 2.4 GHz, 5 GHz, and/or 6-7 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A device comprising:
a memory configured to store channel quality data comprising information indicating a quality of a communication channel between a base station (BS) and a user equipment (UE);
a processor configured to:
provide an input comprising the channel quality data to a machine learning model configured to predict a channel quality indicator (CQI) based on the input;
encode a channel quality information based on the predicted CQI for a transmission to the BS.

2. The device of claim 1,
wherein the channel quality data comprises a plurality of measurement results performed on received radio communication signals via the communication channel;
wherein each measurement result is configured to represent an estimated quality of the communication channel for an instance of time;
wherein the plurality of measurement results comprises one of a plurality of in-phase and quadrature samples based on the received radio communication signals, a plurality of Fast Fourier Transform (FFT) samples based on the received radio communication signals, signal measurements comprising at least one of a reference signal received power (RSRP), a received signal strength indicator (RSSI), or reference signal received quality (RSRQ).

3. The device of claim 2,
wherein the memory is further configured to store context information comprising information indicating at least one of a mobility of the UE, a location of the UE, a velocity of the UE, or a moving direction of the UE relative to the BS;
wherein the input of the machine learning model comprises the context information;
wherein the context information further comprises information indicating at least one of a time, a velocity of the UE, an identifier for a network operator operating through the BS, an identifier of the BS, a network mode, a measured downlink or uplink rate for a period of time, a modulation level, a past power level, a number of resource blocks allocated for the UE, a number of retransmissions to transmit communication signals to the BS.

4. The device of claim 3,
wherein the context information further comprises an indication for at least one of a first instance of time of a generation of at least one previous CQI, a second instance of time of a transmission of information comprising an indication of the at least one previous CQI, or a third instance of time of a downlink communication scheduled in response to the at least one previous CQI, or a predetermined time gap information representing a period of time between a generation of the channel quality information and a reception of the generated channel quality information by the BS.

5. The device of claim 4,
wherein the processor is configured to determine the time gap information based on at least one of the first instance of time, the second instance of time, or the third instance of time using a second machine learning model;
wherein the machine learning model is configured to predict the CQI for an instance of time after a period of time comprising the period of time indicated by the determined time gap information.

6. The device of claim 1, further comprising:
a measurement circuit to perform CQI measurements on a plurality of resource blocks;
wherein the processor is configured to control the measurement circuit to perform a first CQI measurement at a first instance of time;
wherein the processor is configured to control the measurement circuit to perform a second CQI measurement at a second instance of time;
wherein the processor is configured to control the machine learning model to predict the CQI at a third instance of time that is between the first instance of time and the second instance of time.

7. The device of claim 1,
wherein the memory comprises a plurality of machine learning model parameters;
wherein the machine learning model is configured to provide the output based on the machine learning model parameters;
wherein the processor is further configured to adjust the machine learning model parameters based on the determined CQI and a number of retransmissions with the configured radio settings, a received hybrid automatic repeat request (HARQ) feedback, or buffer lengths.

8. The device of claim 1,
wherein the processor is configured to perform application layer functions for an application layer of a communication reference model, and lower layer functions for a lower layer of the communication reference model that is lower than the application layer;
wherein the processor is configured to provide the predicted CQI via a cross-layer information from the lower layer to the application layer using the lower layer functions;
wherein the processor is configured to perform the application layer functions based on the predicted CQI.

9. The device of claim 8,
wherein the processor is configured to adjust at least one of quality of service (QoS) parameters for applications running in the application layer, uplink communication requests of for the applications running in the application layer, or a limit of scheduled uplink traffic for the applications running in the application layer, based on the predicted CQI.

10. A device comprising:
a memory configured to store channel quality data comprising information indicating a quality of a communication channel between a base station (BS) and a user equipment (UE);
a processor configured to:
provide an input comprising the channel quality data to a machine learning model configured to determine a resource management parameter to manage radio resources for the UE based on the input;
configure uplink radio resources for the UE based on the determined resource management parameter.

11. The device of claim 10,
wherein the memory is further configured to store context information comprising information indicating at least one of requests of resources of the UE, quality of service (QoS) parameters with respect to received data from the UE, resource requests and/or QoS parameters with respect to other UEs, detected interference on the communication channel, cell loading of the BS, frequency separation between uplink and downlink;
wherein the input of the machine learning model comprises the context information.

12. The device of claim 10,
wherein the determined resource management parameter comprises a predicted CQI value for the communication channel;
wherein the processor is configured to configure the radio resources for the UE based on the predicted CQI value.

13. A device comprising:
a memory configured to store uplink buffer data comprising information indicating one or more past states of an uplink buffer of a user equipment (UE) used for transmissions to a base station (BS);
a processor configured to:
provide an input comprising the uplink buffer data to a machine learning model configured to predict an uplink transmission to be transmitted to the BS based on the input;
encode a message comprising information indicating the predicted uplink transmission to be transmitted to the BS.

14. The device of claim 13,
wherein the memory is configured to store context information;
wherein the context information comprises at least one of running applications, types of the running applications, quality of service (QoS) requirements of the running applications, an amount of received downlink data at a period of time for a plurality of periods of time, predicted network traffic received from an application layer for the running applications;
wherein the input of the machine learning model further comprises the context information.

15. The device of claim 13,
wherein the processor is configured to obtain at least a portion of the context information from an application layer entity via a cross layer information;
wherein the processor is configured to obtain at least the predicted network traffic and the QoS requirements of the running applications from the application layer entity via a cross layer information.

16. The device of claim 13,
wherein the machine learning model is configured to predict an amount of data to be scheduled for uplink transmission;
wherein the processor is configured to encode the message comprising a buffer status report;
wherein the buffer status report comprises information indicating the predicted amount of data to be scheduled for the uplink transmission;
wherein the encoded message comprises a medium access layer control element (MAC CE) indicating the predicted amount of data to be scheduled for the uplink transmission.

17. The device of claim 13,
wherein the memory comprises a plurality of machine learning model parameters;
wherein the machine learning model is configured to provide the output based on the machine learning model parameters;
wherein the processor is further configured to adjust the machine learning model parameters based on the output of the machine learning model and the amount of data scheduled for the uplink transmission.

18. The device of claim 17,
wherein the processor is configured to adjust the machine learning model parameters based on the amount of data scheduled for the uplink transmission and the predicted amount of data to be scheduled for the uplink transmission.

19. The device of claim 13,
wherein the machine learning model comprises a recursive neural network long short-term memory (LSTM);
wherein the processor is configured to provide the input in a time-series data configuration to the LSTM.

20. The device of claim 19,
wherein the LSTM is configured to provide the output based on input features of a time window comprising a plurality of consecutive instances of time.

21. The device of claim 13,
wherein the machine learning model comprises a reinforcement learning model;
wherein the processor is further configured to determine a first output parameter based on a first state indicated by the input at a first instance of time;
wherein the processor is further configured to determine a reward for an observation state in which the UE communicates according to the configured radio resources according to the first output parameter;
wherein the processor is further configured to determine a second output parameter based on the determined reward and a second state indicated by the input at a second instance of time.

22. The device of claim 21,
wherein the processor is configured to determine the reward for the observation state based on the amount of data scheduled for the uplink transmission.

23. The device of claim 21,
wherein the reinforcement learning model comprises a multi-armed bandit reinforcement learning model.

24. A device comprising:
a memory configured to store uplink communication activity data comprising information indicating uplink communication activities between one or more user equipments (UEs) and a base station (BS);
a processor configured to:
provide an input comprising the uplink communication activity data to a machine learning model configured to predict an uplink communication activity of a respective UE of the one or more UEs based on the input;
configure uplink channel radio resources for the respective UE based on the predicted uplink communication activity.

25. The device of claim 24,
wherein the predicted communication activity comprises a predicted buffer status report;
wherein the processor is configured to allocate resources for the UE based on the predicted buffer status report;
wherein the processor is configured to encode a message indicating configured uplink radio resources to be transmitted to the respective UE.
